(19) United States
(12) Patent Application Publication
(10) Pub. No.: US 2007/0064809 A1
(43) Pub. Date: Mar. 22, 2007

(54) Coding method for coding moving images

(76) Inventors: Tsuyoshi Watanabe, Gifu-shi (JP); Shinichiro Okada, Toyohashi-shi (JP); Yasuo Ishii, Anpachi-gun (JP); Shigeyuki Okada, Ogaki-shi (JP); Hideki Yamauchi, Ogaki-shi (JP); Yuh Matsuda, Gifu-shi (JP); Yoshihiro Matsuo, Hashima-shi (JP); Haruhiko Murata, Osaka (JP)

Correspondence Address: MCDERMOTT WILL & EMERY LLP, 600 13TH STREET, N.W., WASHINGTON, DC, 20005-3096, US

(21) Appl. No.: 11/520,859

(22) Filed: Sep. 14, 2006

(30) Foreign Application Priority Data
Sep. 14, 2005 (JP) 2005-267646
Sep. 27, 2005 (JP) 2005-280880
Jun. 30, 2006 (JP) 2006-182515
Jun. 30, 2006 (JP) 2006-182615

(51) Int. Cl. H04N 11/02; H04N 11/04

(52) U.S. Cl. 375/240.16; 375/240.24

(57) ABSTRACT

A motion vector holding unit 61 holds motion vector information with respect to a backward reference frame detected beforehand and received from a motion compensation unit 60. A motion vector calculation unit 63 calculates multiple motion vectors for each macro block defined in a coding target frame with reference to the motion vector information with respect to the backward reference frame held by the motion vector holding unit 61 according to each calculation mode of a set of different calculation modes. A motion compensation prediction unit 64 performs motion compensation using motion vectors obtained for each calculation mode, thereby creating predicted images. The predicted images are output to a coding amount estimation unit 65. The coding amount estimation unit 65 estimates the coding amount of the subtraction image, which is the subtraction between the predicted image and the original image, for each calculation mode. A motion vector selection unit 67 makes a comparison between the coding amounts of the subtraction images, and selects the motion vector which provides the smallest coding amount.

### BACKGROUND OF THE INVENTION

1. Field of the Invention

The present invention relates to a coding method for coding moving images.

2. Description of the Related Art

The rapid development of broadband networks has increased consumer expectations for services that provide high-quality moving images. Large capacity storage media such as DVD and so forth are used for storing high-quality moving images. This increases the segment of users who enjoy high-quality images. A compression coding method is an indispensable technique for transmission of moving images via a communication line, and storing the moving images in a storage medium. Examples of international standards of moving image compression coding techniques include the MPEG-4 standard, and the H.264/AVC standard. Furthermore, the SVC (Scalable Video Coding) technique is known, which is a next-generation image compression technique that includes both high quality image streaming and low quality image streaming functions.

Streaming distribution of high-resolution moving images without taking up most of the communication bandwidth, and storage of such high-resolution moving images in a recording medium having a limited storage capacity, require an increased compression ratio of a moving image stream. In order to improve the effects of the compression of moving images, motion compensated interframe prediction coding is performed. With motion compensated interframe prediction coding, a coding target frame is divided into blocks, and the motion between the target coding frame and a reference frame, which has already been coded, is predicted so as to detect a motion vector for each block, and the motion vector information is coded together with the subtraction image.

Japanese Patent Application Laid-open Publication No. 2-219391 discloses a motion compensation prediction coding method having a mechanism in which, in a case that determination has been made that a predicted motion vector, which is predicted based upon the residual motion vector and the number of the residual frames, is close to the motion vector obtained between the adjacent frames, the predicted motion vector, which has been determined to be close to the motion vector obtained between the adjacent frames, is employed as the motion vector for motion compensation prediction coding. In a case that determination has been made that the predicted motion vector is not close to the motion vector obtained between the adjacent frames, the motion vector obtained between the adjacent frames is employed as the motion vector for motion compensation prediction coding.

The H.264/AVC standard provides a function of adjusting the motion compensation block size, and a function of selecting the improved motion compensation pixel precision of down to ¼ pixel precision, thereby enabling finer prediction to be made for the motion compensation. In the development of SVC (Scalable Video Coding), which is a next-generation image compression technique, MCTF (Motion Compensated Temporal Filtering) technique is being studied in order to improve temporal scalability. The MCTF technique is a technique in which the time-base sub-band division technique and the motion compensation technique are combined. With the MCTF technique, motion compensation is performed in a hierarchical manner, leading to significantly increased information with respect to the motion vectors. As described above, according to the recent trends, such a latest moving image coding technique requires the increased overall amount of data for the moving image stream due to the increased amount of information with respect to the motion vectors. This leads to a strong demand for a technique of reducing the coding amount due to the motion vector information.

### SUMMARY OF THE INVENTION

The present invention has been made in view of the aforementioned problems. Accordingly, it is an object thereof to provide a moving image coding technique which offers high coding efficiency.

In order to solve the aforementioned problems, a coding method according to one aspect of the present invention is a coding method for coding pictures of a moving image, in which a first motion vector is obtained for each block defined in a coding target picture by a method of matching each block defined in a reference picture and this same block defined in the coding target picture. Furthermore, at least one second motion vector is obtained for each block defined in the coding target picture using methods other than the matching method. With such an arrangement, coded data of the moving image includes the information which defines one motion vector selected from among the multiple motion vectors thus prepared.

The term “picture” as used herein represents a coding unit. The concept thereof includes the frame, field, and VOP (Video Object Plane). The term “each block defined in a coding target picture” as used here represents a pixel set formed of multiple pixels included in a predetermined region such as a macro block or an object, which serves as a target of motion compensation prediction.

With such an aspect, a single motion vector is selected for each block from among multiple motion vectors prepared beforehand. This provides coding of a moving image using motion vectors which are appropriate for the situation.

Note that the motion vector may be selected as follows. That is to say, inter-picture prediction is performed using each of multiple motion vectors, thereby obtaining predicted images. Then, the motion vector which provides the smallest coding amount of the subtraction image, which is the difference between the predicted image thus obtained and the original image, is selected from among the multiple motion vectors. Such an arrangement reduces the data amount of the coded data of a moving image, thereby improving the coding efficiency.

In a case that there is a second reference picture for which motion vectors have been obtained with a first reference picture as a reference, the second motion vector may be obtained for each block defined in the coding target picture using the motion vector of the corresponding block defined in the second reference picture.

With such an arrangement, the motion vectors for the coding target picture are represented using the motion vectors calculated beforehand for the reference picture. Such an arrangement reduces the coding amount of the motion vector data component.

As an example, the “first motion vector” corresponds to the motion vector MV_{B} obtained in the calculation mode 1 according to the Embodiment 1. The “second motion vector” corresponds to the motion vector obtained in any one of the calculation modes 2 through 5 according to the Embodiment 1.

Note that the motion vector which provides the smaller coding amount for the subtraction image may be selected from among the first motion vector and the second motion vector. With such an arrangement, the motion vectors which provide the smallest coding amount of the subtraction image are selected. This reduces the data amount of the coded data of a moving image, thereby improving the coding efficiency.

A target block, which serves as a motion compensation prediction target for the coding target picture, may be detected based upon each block defined in the second reference picture and the reference motion vector corresponding to the block. Furthermore, a second motion vector of the block thus detected may be calculated by calculating the product of the reference motion vector and a proportional coefficient obtained based upon the distance in time between the second reference picture and the coding target picture.

The term “proportional coefficient obtained based upon the distance in time” as used here represents the coefficient obtained based upon the time interval between the reference picture and the coding target picture, and the speed or acceleration of the block, on the assumption that the block moves at a constant speed or a constant acceleration.

With such an arrangement, the motion vector can be defined using the proportional coefficients alone, thereby further reducing the coding amount of the motion vector data.

An adjustment vector that represents the estimated value of a difference between the first motion vector and the second motion vector may be obtained. Furthermore, the multiple motion vectors may include a composite vector formed of the adjustment vector and the second motion vector. With such an arrangement, the adjustment vector, which is a component of the composite vector, increases the precision of the motion compensation prediction. This reduces the data amount of the coded data of a moving image.

The motion vector selected for the coding target picture may be employed as a new reference motion vector. Furthermore, the new reference motion vector may be used for defining the motion vector for another coding target picture. With such an arrangement, each motion vector for a coding target picture is defined using the corresponding motion vector for a reference picture defined beforehand using the corresponding vector obtained for another reference picture. Such an arrangement reduces the coding amount of the motion vector data for each coding target picture, thereby improving the coding efficiency for a moving image.

The coded data may include the mode information which indicates which motion vector is selected and used from among the multiple motion vectors. With such an arrangement, each motion vector can be defined using the mode information, the proportional coefficients and the adjustment vectors for the motion vector, included in the coded data. Such an arrangement reduces the coding amount of the motion vector data.

Note that any combination of the aforementioned components or any manifestation of the present invention realized by modification of a method, device, system, computer program, and so forth, is effective as an embodiment of the present invention.

### BRIEF DESCRIPTION OF THE DRAWINGS

FIG. 1 is a configuration diagram which shows a coding device according to an Embodiment 1;

FIG. 2 is a diagram for describing a conventional calculation procedure for calculating motion vectors;

FIG. 3 is a diagram for describing the configuration of a motion compensation unit shown in FIG. 1;

FIG. 4 is a diagram which shows an example of calculation modes for calculating a motion vector;

FIG. 5 is a diagram for describing a calculation method for calculating motion vectors;

FIG. 6 is a diagram for describing a calculation method for calculating motion vectors;

FIG. 7 is a diagram for describing a calculation method for calculating motion vectors;

FIG. 8 is a diagram for describing a proportional coefficient α for representing constant-speed motion;

FIG. 9 is a diagram for describing a proportional coefficient α for representing constant-acceleration motion;

FIG. 10 is a flowchart which shows a selection method for selecting the optimum motion vector;

FIG. 11 is a flowchart which shows a method for obtaining the coding amount of a composite motion vector formed using the proportional coefficient α and an adjustment vector β each of which is adjusted in a predetermined range;

FIG. 12 is a diagram which shows the configuration of a decoding device according to the Embodiment 1;

FIG. 13 is a configuration diagram which shows a motion compensation unit shown in FIG. 12;

FIG. 14 is a diagram which shows coding of four frames according the MCTF technique;

FIG. 15 is a configuration diagram which shows a coding device according to an Embodiment 2;

FIG. 16 is a diagram for describing a conventional calculation procedure for calculating motion vectors;

FIG. 17 is a diagram for describing a motion compensation unit shown in FIG. 15;

FIGS. 18A and 18B are diagrams for describing a proportional coefficient α in a constant-speed motion mode;

FIGS. 19A and 19B are diagrams for describing a proportional coefficient α in a constant-acceleration motion mode;

FIGS. 20A and 20B are diagrams for describing a proportional coefficient α in an irregular motion mode;

FIG. 21 is a diagram for describing a calculation method for calculating an adjustment vector β;

FIG. 22 is a flowchart which shows a coding method for coding a motion vector according to the Embodiment 2;

FIG. 23 is a table which shows an example of the motion modes for the motion vectors and the corresponding codes;

FIG. 24 is a table which shows an example of the constant values for approximating the coefficients α and the codes assigned to the constant values;

FIG. 25 is a diagram which shows a decoding device according to the Embodiment 2;

FIG. 26 is a configuration diagram which shows a motion compensation unit shown in FIG. 25; and

FIG. 27 is a diagram which shows coding of four frames according to the MCTF technique.

### DETAILED DESCRIPTION OF THE INVENTION

The invention will now be described by reference to the preferred embodiments. This does not intend to limit the scope of the present invention, but to exemplify the invention.

### Embodiment 1

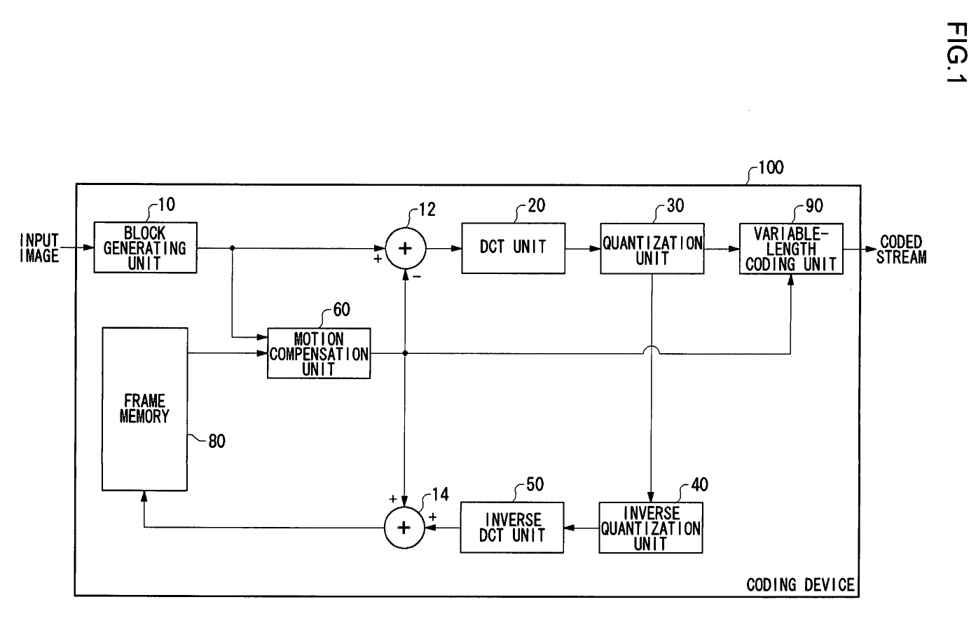

FIG. 1 is a configuration diagram which shows a coding device 100 according to an embodiment 1. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 100 according to the present embodiment performs coding of moving images according to the MPEG (Moving Picture Experts Group) series standards (MPEG-1, MPEG-2, and MPEG-4) standardized by the international standardization organization ISO (International Organization for Standardization)/IEC(International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the aforementioned standardization organizations (these organizations have advised that this H.264/AVC standard should be referred to as “MPEG-4 Part 10: Advanced Video Coding” and “H.264”, respectively).

With the MPEG series standards, in a case of coding an image frame in the intra-frame coding mode, the image frame to be coded is referred to as “I (Intra) frame”. In a case of coding an image frame with a prior frame as a reference image, i.e., in the forward interframe prediction coding mode, the image frame to be coded is referred to as “P (Predictive) frame”. In a case of coding an image frame with a prior frame and an upcoming frame as reference images, i.e., in the bi-directional interframe prediction coding mode, the image frame to be coded is referred to as “B frame”.

On the other hand, with the H.264/AVC standard, image coding is performed using reference images regardless of the time at which the reference images have been acquired. For example, image coding may be made with two prior image frames as reference images. Image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

Note that, in the present specification, the term “frame” has the same meaning as that of the term “picture”. Specifically, the “I frame”, “P frame”, and “B frame” will also be referred to as the “I picture”, “P picture”, and “B picture”, respectively.

Description will be made in the present specification regarding an arrangement in which coding is performed in units of frames. Coding may be made in units of fields. Coding may be made in units of VOPs stipulated in the MPEG-4.

The coding device 100 receives an input moving image in units of frames, performs coding of the moving image, and outputs a coded stream.

A block generating unit 10 divides an input image frame into macro blocks. The block generating unit 10 creates macro blocks in order from the upper-left region to the lower-right region of the frame. The block generating unit 10 supplies the macro blocks thus generated to a subtractor 12 and a motion compensation unit 60.

In a case that the image frame supplied from the block generating unit 10 is an I frame, the subtractor 12 outputs the image frame thus received to a DCT unit 20 without any processing. On the other hand, in a case that the image frame supplied from the block generating unit 10 is a P frame or B frame, the subtractor 12 calculates the difference between the frame thus received and a predicted image supplied from the motion compensation unit 60, and outputs the difference to the DCT unit 20.

The motion compensation unit 60 employs a prior frame or an upcoming frame stored in frame memory 80 as a reference image. Then, the motion compensation unit 60 searches the reference image for the predicted region which provides the smallest difference for each macro block defined in the P frame or B frame input from the block generating unit 10, thereby obtaining the motion vector which represents the displacement from the macro block to the predicted region. The motion compensation unit 60 performs motion compensation for each macro block using the motion vector, thereby creating a predicted image. The motion compensation unit 60 supplies the motion vector thus created to a variable-length coding unit 90, and the predicted image thus created to the subtractor 12 and an adder 14.

The motion compensation unit 60 has a function of selecting a prediction mode from among the bi-directional prediction mode and the uni-directional prediction mode. In a case of employing the uni-directional prediction mode, the motion compensation unit 60 generates a forward motion vector which represents the motion with respect to a forward reference frame. On the other hand, in a case of employing the bi-directional prediction, the motion compensation unit 60 generates two kinds of motion vectors, i.e., a backward motion vector which represents the motion with respect to a backward reference frame, in addition to the aforementioned forward motion vector.

The subtractor 12 calculates the difference between the current image (i.e., the coding target image) output from the block generating unit 10 and the predicted image output from the motion compensation unit 60, and outputs the difference thus obtained to the DCT unit 20. The DCT unit 20 performs discrete cosine transform (DCT) processing for the subtraction image supplied from the subtractor 12, and supplies the DCT coefficients thus obtained to a quantization unit 30.

The quantization unit 30 quantizes the DCT coefficients, and supplies the DCT coefficients thus quantized to the variable-length coding unit 90. The variable-length coding unit 90 performs variable-length coding of the quantized DCT coefficients of the subtraction image along with the motion vector supplied from the motion compensation unit 60, thereby creating a coded stream. Note that the variable-length coding unit 90 creates the coded stream while sorting the coded frames in time order.

The quantization unit 30 supplies the quantized DCT coefficients of the image frame to an inverse quantization unit 40. The inverse quantization unit 40 performs inverse-quantization of the quantized data thus received, and supplies the data ubjected to inverse-quantization to an inverse-DCT unit 50. The inverse-DCT unit 50 performs inverse discrete cosine transform processing for the inverse-quantized data thus received. As a result, the original image is reconstructed from the coded image frame. The original image thus reconstructed is input to the adder 14.

In a case that the image frame supplied from the inverse-DCT unit 50 is an I frame, the adder 14 stores the image frame thus received in the frame memory without any processing. On the other hand, in a case that the image frame supplied from the inverse-DCT unit 50 is a P frame or a B frame, i.e., is a subtraction image, the adder 14 calculates the sum of the subtraction image supplied from the inverse-DCT unit 50 and the predicted image supplied from the motion compensation unit 60, thereby reconstructing the original image. Then, the original image thus reconstructed is stored in the frame memory 80.

Description has been made regarding coding processing for a P frame or B frame, in which the motion compensation unit 60 operates as described above. On the other hand, in a case of coding processing for an I frame, the I frame subjected to intra-frame prediction is supplied to the DCT unit 20 without involving the motion compensation unit 60. Note that this coding processing is not shown in the drawings.

Next, description will be made regarding a conventional method for calculating motion vectors. Then, description will be made regarding calculation of motion vectors according to the Embodiment 1.

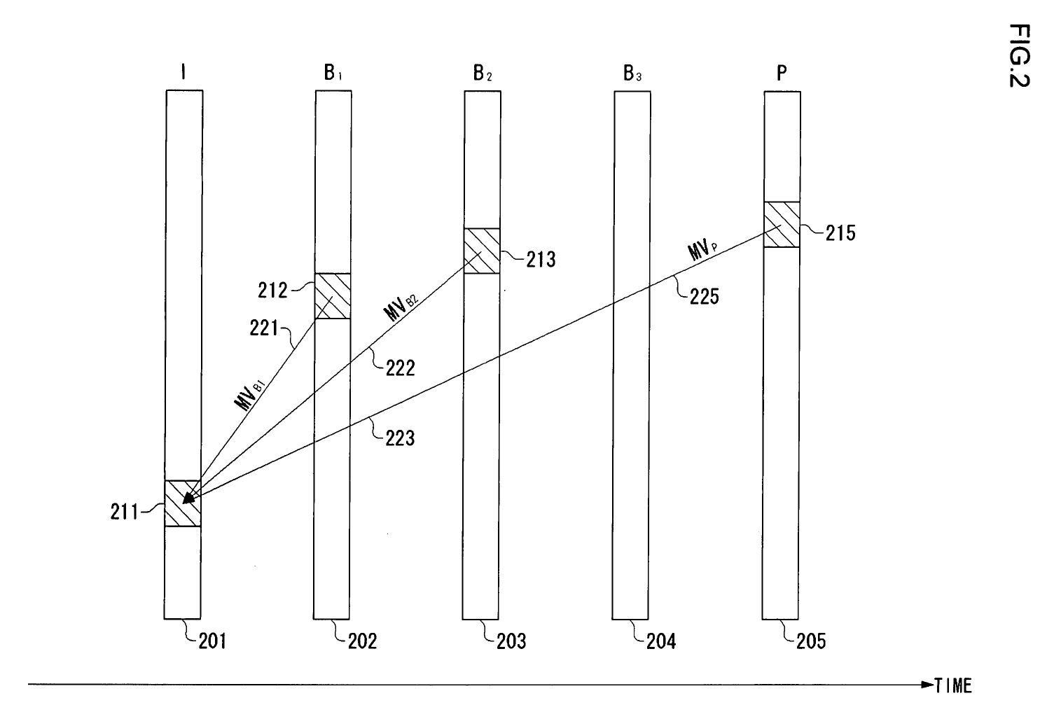

FIG. 2 is a diagram for describing conventional calculation of motion vectors. In this drawing, five frames are shown in order of display time, with the movement from left to right representing the passage of time. Specifically, I frame 201, B₁ frame 202, B₂ frame 203, B₃ frame 204, and P frame 205 are displayed in that order. Note that the order of coding differs from the order of display. Specifically, first, the I frame 201 in this drawing is coded. Then, motion compensation is performed for the fifth frame, i.e., the P frame 205, using the I frame 201 as a reference image. Subsequently, the B₂ frame 203 is coded. Then, motion compensation is performed for the B₁ frame 202 and the B₃ frame 204 in that order, and coding thereof is performed.

A prior I frame or P frame is employed as a reference frame for coding a target P frame. On the other hand, a prior I frame or a prior or upcoming P frame is employed as a reference frame for coding a target B frame. Here, motion compensation prediction is performed for the P frame using a single motion vector for each 16×16 macro block, for example. On the other hand, motion compensation is performed for the B frame using the one optimum motion compensation mode selected from among three possible options, i.e., the forward prediction mode, the backward prediction mode, and the bi-directional prediction mode. Note that the I frame 201 may be replaced by a P frame. The P frame 205 may be replaced by an I frame.

Let us say that the flow enters the stage for coding the B₁ through B₃ frames 202-204 after coding of the I frame 201 and P frame 205 has been completed. In this stage, the B₁ through B₃ frames 202-204 will be referred to as the “coding target frames”. The I frame 201, which is displayed prior to the coding target frames will be referred to as the “forward reference frame”. The P frame 205, which is displayed after the coding target frames, will be referred to as the “backward reference frame”. The motion vector of the P frame 205 will be represented by “MV_{P}”. The motion vectors of the B₁ through B₃ frames will be represented by “MV_{B1}” through “MV_{B3}”.

Note that, while FIG. 2 shows each two-dimensional frame in a one-dimensional manner, each actual motion vector has two-dimensional components, i.e., horizontal-direction component and the vertical-direction component.

As shown in FIG. 2, the motion vector first obtained is the motion vector MV_{P} 225 which indicates the displacement of the macro block 215 defined in the P frame 205 toward the corresponding macro block 211 defined in the forward reference frame 201. The motion vector next obtained is the motion vector MV_{B2} 222 which indicates the displacement of the macro block 213 defined in the coding target frame 203 toward the corresponding macro block defined in either the forward reference frame 201 or the backward reference frame 205. FIG. 2 shows an arrangement in which the motion vector indicates the displacement of the macro block 213 toward the corresponding macro block defined in the forward reference frame 201. Subsequently, the motion vector next obtained is the motion vector MV_{B1} 221 which indicates the displacement of the macro block defined in the coding target frame 202 toward the corresponding macro block defined in either the forward reference frame 201 or the backward reference frame 205.

On the other hand, with the present Embodiment 1, multiple motion vectors are calculated in different manners for each macro block defined in the B frame. The calculation of the motion vectors is performed using the motion vectors obtained beforehand for the backward reference frame. Such calculation provides a reduced coding amount of the motion vector data of the B frame.

Furthermore, with the present Embodiment 1, motion compensation is performed for the B frame using multiple motion vectors, thereby obtaining predicted images. Then, the subtraction image is obtained between each of the predicted images and the original image. Subsequently, the motion vector which provides the subtraction image that exhibits the smallest coding amount is selected. Such an arrangement provides a reduced coding amount of the coded data of a moving image, thereby improving the coding efficiency.

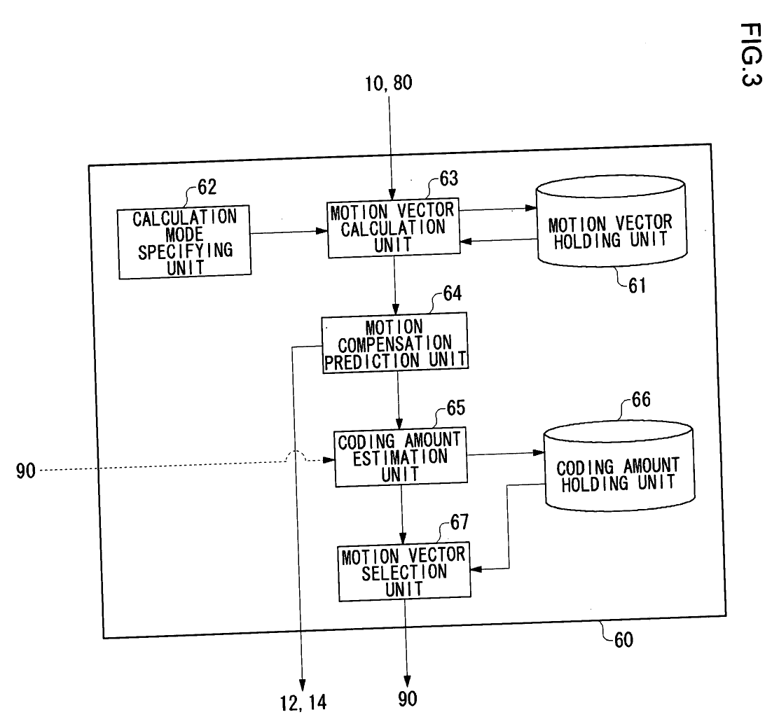

FIG. 3 is a diagram for describing the configuration of the motion compensation unit 60 according to the present Embodiment 1.

At the time of motion compensation of the backward reference frame 205, the motion compensation unit 60 detects the motion vector for each macro block defined in the backward reference frame 205. The motion vector information with respect to the backward reference frame 205 thus detected is held by a motion vector holding unit 61.

A motion vector calculation unit 63 calculates multiple motion vectors defined in different manners for each macro block defined in the coding target frames 202-204 with reference to the information with respect to the motion vectors for the backward reference frame 205 stored in the motion vector holding unit 61. Description will be made in the present Embodiment 1 regarding an arrangement in which multiple motion vectors are obtained in different manners for each macro block, with each of the different manners being referred to as a “calculation mode”. The calculation mode is supplied from a calculation mode specifying unit 62 to the motion vector calculation unit 63.

The motion compensation prediction unit 64 performs motion compensation using the motion vector obtained for each calculation mode, thereby creating predicted images. The predicted images thus created are output to a coding estimation unit 65, the subtractor 12, and the adder 14.

A coding amount estimation unit 65 estimates the coding amount in a case of coding the subtraction image, which is the subtraction between the predicted image and the original image, for each calculation mode. Each coding amount thus estimated is held by a coding amount holding unit 66 in correlation with the corresponding calculation mode.

A motion vector selection unit 67 makes a comparison between the coding amounts of the subtraction images held by the coding amount holding unit 66, and selects the motion vector which provides the smallest coding amount. The motion vector information thus selected is output to the variable-length coding unit 90. The motion vector information is subjected to variable-length coding together with the image, thereby creating a coded stream including the motion vector information.

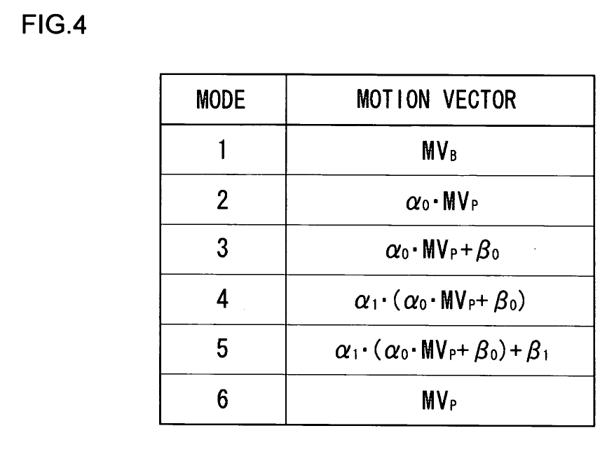

FIG. 4 shows an example of calculation modes for calculating the motion vectors, which are specified by the calculation mode specifying unit 62. With the present Embodiment 1, six kinds of calculation modes are defined, i.e., the calculation modes 1 through 6. Specifically, in the calculation mode 1, each of the motion vectors MV_{B} obtained for the coding target frames 202-204 is used without any calculation. The calculation mode 2 employs the motion vector obtained by multiplying the motion vector MV_{P}, obtained beforehand for the backward reference frame 205, by a proportional coefficient α₀. The calculation mode 3 employs the motion vector obtained by adding an adjustment vector β₀ to the motion vector obtained in the calculation mode 2. The calculation mode 4 employs the motion vector obtained by multiplying all the components of the motion vector obtained in the calculation mode 3 by a proportional coefficient α₁. The calculation mode 5 employs the motion vector obtained by adding an adjustment vector β₁ to the motion vector obtained in the calculation mode 4. The calculation mode 6 employs the motion vector MV_{P} of the backward reference frame 205 without any calculation.

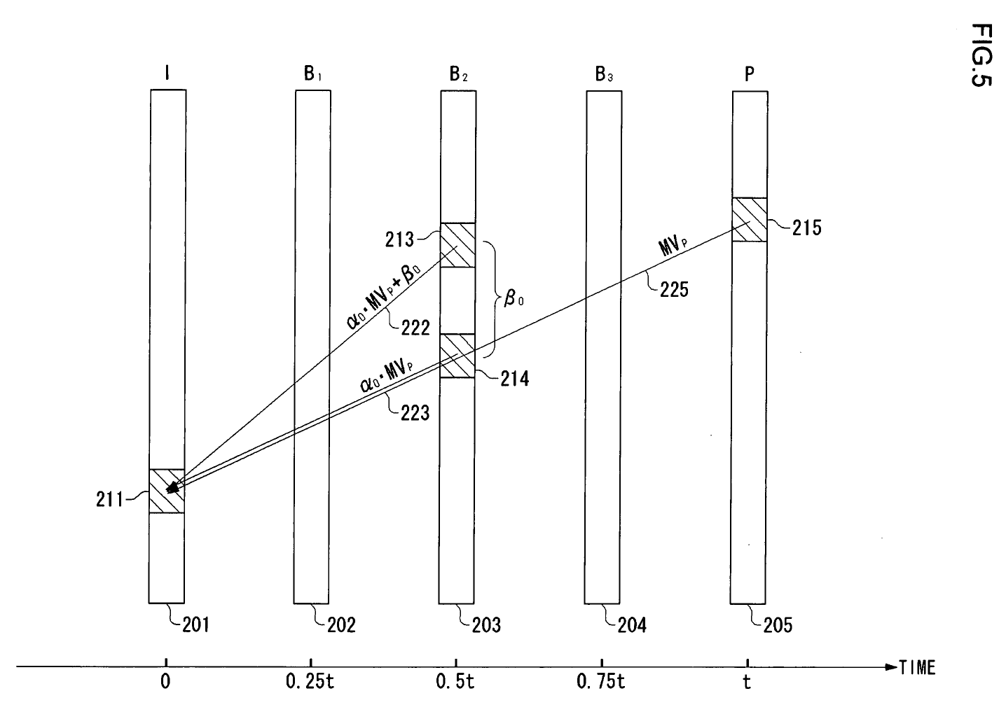

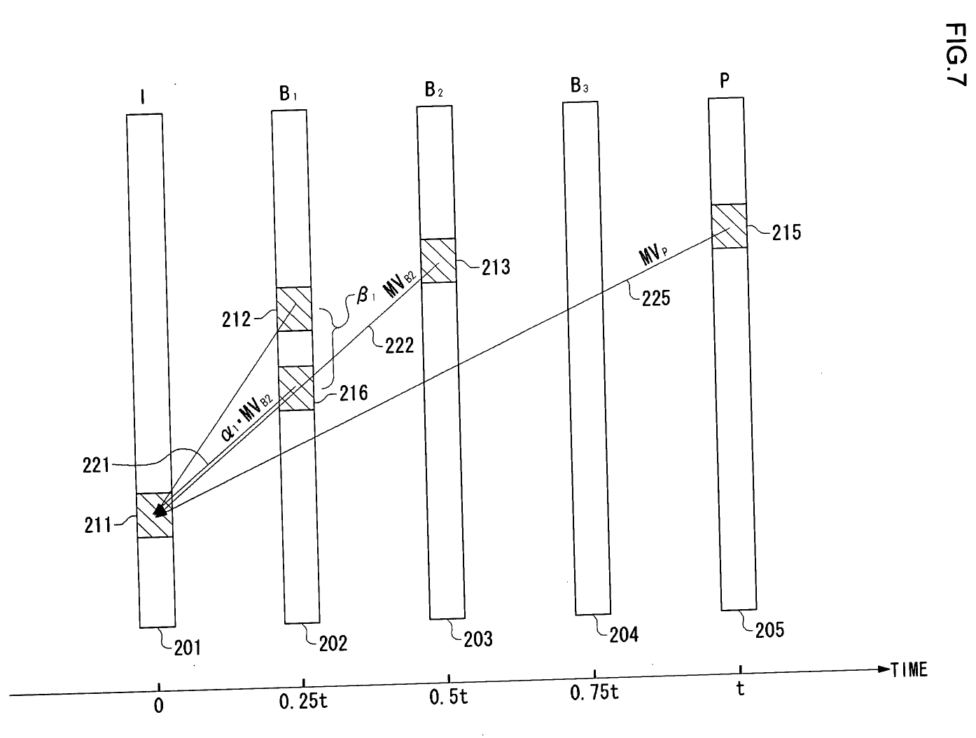

Referring to FIGS. 5 through 7, description will be made regarding calculation of motion vectors with the B₂ frame 203 or the B₁ frame 202 as a coding target frame according to each of the aforementioned calculation modes 1 through 6. Note that, in FIGS. 5 through 7, the same components as those in FIG. 2 are denoted by the same reference numerals, and description which is the same as that made with reference to FIG. 2 will be omitted.

In the calculation mode 1, the motion vector MV_{B} detected using the conventional method is employed. Let us consider an example shown in FIG. 2. In this case, the forward reference frame 201 is searched for a predicted region, which exhibits the smallest difference from the macro block 213 defined in the coding target frame 203, by the matching method. Then, the motion vector MV_{B2}, which represents the displacement from the macro block 213 to the predicted region, is obtained.

In the calculation mode 2, the motion vector is obtained by distributing all the components of the motion vector MV_{P} (which will also be referred to as the “reference motion vector” hereafter) obtained beforehand for the macro block defined in the backward reference frame 205 (which will also be referred to as the “reference macro block” hereafter) in proportion to the distance in time between the target coding frame and the forward reference frame. Here, the proportional coefficient will be represented by “α₀”.

Referring to FIG. 5, the macro block 214, which serves as a target of motion compensation prediction in the coding target frame 203, is detected based upon the macro block 215 defined in the backward reference frame 205 and the corresponding reference motion vector MV_{P} 225. Then, α₀·MV_{P} is calculated, and the calculation result α₀·MV_{P} is employed as the motion vector of the macro block 214 thus detected.

Note that the macro block defined in the coding target frame, which serves as a target of motion compensation prediction, is detected based upon the macro block defined in the backward reference frame and the corresponding motion vector according to the following procedure. That is to say, first, the motion vector is obtained for the macro block defined in the coding target frame using an ordinary block matching method or the like (which will be referred to as the “ordinary motion vector” in this step). Subsequently, a particular region, including the position indicated by the ordinary motion vector, is determined in the coding target frame. Then, the motion vector which passes through the region thus determined is extracted from among the motion vectors obtained for the backward reference frame. In a case that multiple motion vectors have been extracted, the motion vector which is closest to the ordinary motion vector obtained beforehand is selected. The motion vector thus extracted or selected serves as the reference motion vector MV_{P} which is to be used as the reference in obtaining the motion vector for the macro block defined in the coding target frame. Thus, the motion vector is calculated for each macro block defined in the coding target frame based upon the reference motion vector MV_{P}.

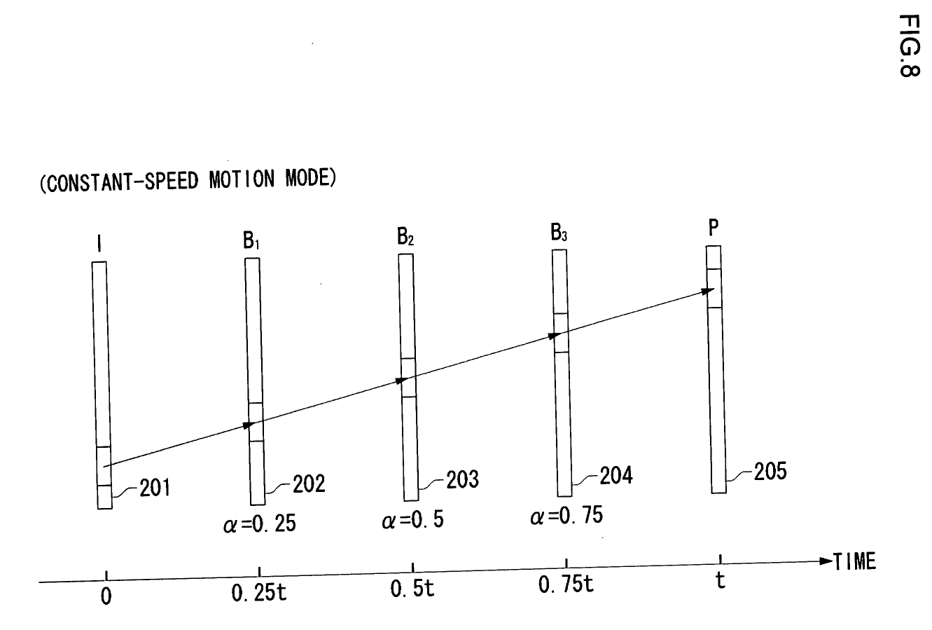

FIG. 8 is a diagram for specifically describing the proportional coefficient α₀ in the linear motion model. Here, the motion vector MV_{P} obtained for the reference macro block 215 (see FIG. 5) defined in the backward reference frame 205 represents the amount and the direction of the movement of the reference macro block 215 for a period of time from the forward reference frame 201 to the backward reference frame 205. Let us say that the macro block moves at a constant speed. In this case, according to the linear motion model, it is predicted that the target macro block 214 will exhibit the movement MV_{P}×(tr/t) for a period of time tr between the coding target frame 203 and the forward reference frame 201. Accordingly, the proportional coefficients α₀ of 0.25, 0.50, and 0.75, are employed for the B₁ frame 202, B₂ frame 203, and B₃ frame 204, respectively.

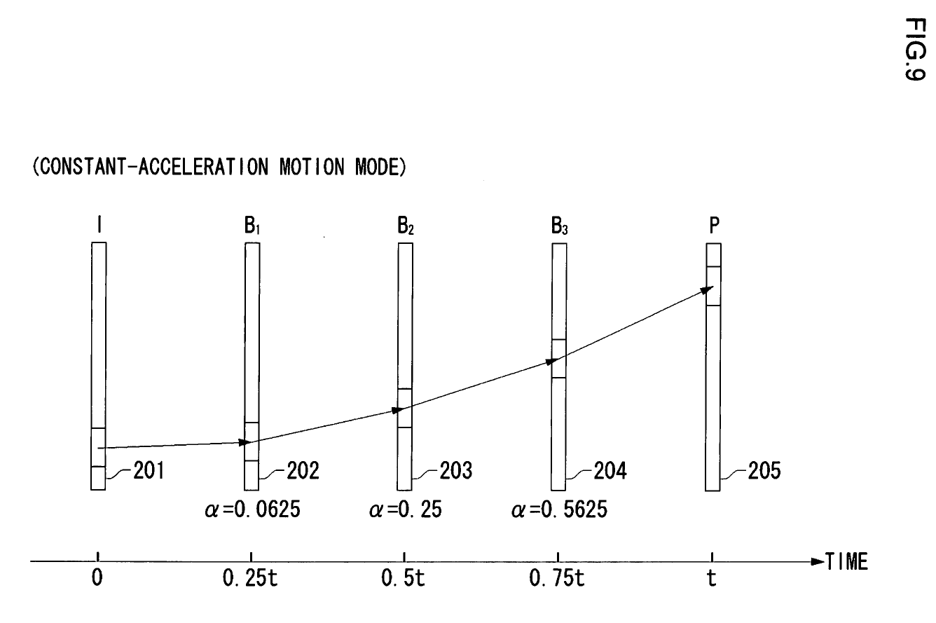

The proportional coefficient α₀ may be determined according to a motion model other than the linear motion model, e.g., according to a constant acceleration motion model. FIG. 9 shows an example of the proportional coefficients α₀ determined according to the constant acceleration motion model. In FIG. 9, each proportional coefficient α₀ is determined to be a coefficient proportional to the square of the time interval between the coding target frame and the forward reference frame. Specifically, the proportional coefficients α₀ of 0.0625, 0.25, and 0.5625, are employed for the B₁ frame 202, B₂ frame 203, and B₃ frame 204, respectively.

The calculation mode 3 employs the composite vector obtained by adding an adjustment vector β₀ to the motion vector α₀·MV_{P} obtained in the calculation mode 2. That is to say, the composite vector α₀·MV_{P}+β₀ is employed.

The adjustment vector β₀ corresponds to the difference between the MV_{B} obtained in the calculation mode 1 and α₀·MV_{P} obtained in the calculation mode 2. That is to say, it is not always the case that the macro block moves at a constant speed over the multiple frames. Accordingly, the motion vector calculation unit 63 obtains the adjustment vector β₀ which represents the difference between the position of the target macro block 214 after movement obtained by linear prediction and the actual position.

The adjustment vector β₀ may be set to a predetermined value. The average of the differences obtained for the nearby macro blocks may be employed as the adjustment vector β₀. A predetermined range may be searched in a scanning manner for a pair of the proportional coefficient α₀ and the adjustment vector β₀ that exhibits the best match between the two, i.e., that provides the smallest coding amount of the subtraction image.

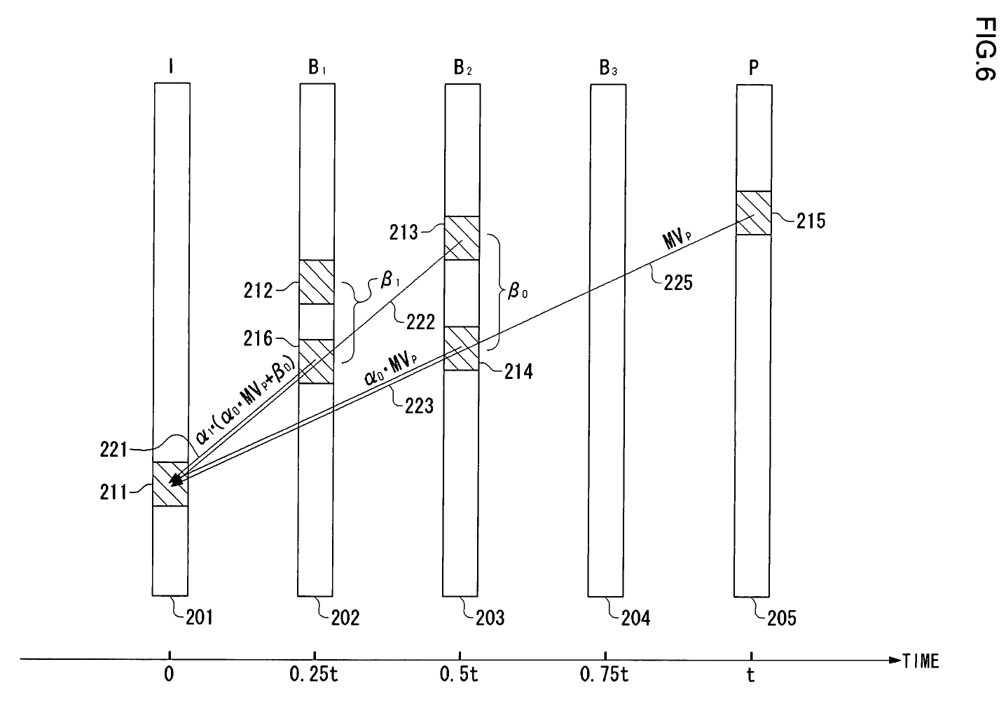

In the calculation mode 4, the motion vector is calculated by further multiplying the motion vector, obtained in the calculation mode 3, by the proportional coefficient “α₁”. Description will be made regarding this calculation with reference to FIG. 6.

Let us say that the flow proceeds to the stage where the motion vector α₀·MV_{P}+β₀ has already been obtained in the calculation mode 3 for the macro block 213 defined in the B₂ frame 203. Now, let us consider the next step in which the motion vector is calculated for the macro block 216 defined in the B₁ frame (coding target frame) 202.

In this step, the corresponding macro block 216 defined in the coding target frame 202 is detected based upon the macro block defined in the B₂ frame 203 and the motion vector thereof. The motion vector of the macro block 216 can be obtained with the motion vector MV_{P} 225 of the backward reference frame 205 as a reference. The motion vector of the macro block 216 can be obtained with the B₂ frame 203 as the backward reference frame, i.e., using the motion vector (α₀·MV_{P}+β₀) 222 as a reference. Of these two manners, in the former manner, the motion vector can be represented by α₀·MV_{P} according to the calculation mode 1. On the other hand, in the latter manner, the motion vector can be represented by α₁·(α₀·MV_{P}+β₀), using the proportional coefficient α₁.

Another arrangement may be made in which the motion vector obtained in the calculation mode 4 is defined to be α₁·MV_{B2}, using the MV_{B2} obtained in the calculation mode 1. Such an arrangement does not require coding of the proportional coefficient α₀ and the adjustment coefficient β₀ in the form of motion vector information, thereby further reducing the coding amount of the motion vector information.

As described above, with the present embodiment, the motion vector can be calculated for a certain coding target frame using the motion vector which has been selected for another coding target frame as the optimum motion vector that provides the smallest coding amount.

The calculation mode 5 employs the composite vector obtained by adding an adjustment vector β₁ to the motion vector α₁·(α₀·MV_{P}+β₀) obtained in the calculation mode 4 in the same way as with the calculation mode 3. The adjustment vector β₁ corresponds to the difference between the motion vector MV_{B1} according to the calculation mode 1 and the motion vector α₁·(α₀·MV_{P}+β₀) according to the calculation mode 4. The adjustment vector β₁ is obtained in the same way as with the adjustment vector β₀.

That is to say, the composite vector according to the calculation mode 5 is represented as follows.
α₁·(α₀·MV_{P}+β₀)+β₁

Another arrangement may be made in which the motion vector obtained in the calculation mode 5 is defined to be α₁·MV_{B2}+β₁ using the motion vector MV_{B2} according to the calculation mode 1. Such an arrangement does not require the coding of the proportional coefficient α₀ and the adjustment coefficient β₀ in the form of motion vector information, thereby further reducing the coding amount of the motion vector information.

The calculation mode 6 employs the motion vector MV_{P} 225 of the backward reference frame 205 without any calculation.

The variable-length coding unit 90 includes in the coded data the mode information which indicates which motion vector has been selected and used from among the motion vectors obtained according to the calculation modes 1 through 6.

Note that, in a case that determination has been made that the motion vector obtained in a different calculation mode provides a smaller coding amount of the subtraction image than that provided using the motion vector MV_{B} obtained according to an ordinary procedure, the motion vector selection unit 67 may select the motion vector obtained according to this calculation mode that differs from the ordinary procedure, instead of another arrangement in which comparison is made between the coding amounts of the subtraction images each of which is obtained using the motion vector obtained according to the corresponding calculation mode for all the calculation modes specified by the calculation mode specifying unit 62.

Specifically, first, the motion compensation unit 64 calculates the motion vector MV_{B} according to the calculation mode 1. Then, the coding amount estimation unit 65 calculates the coding amount of the subtraction image with a predicted image created using the motion vector MV_{B}. Subsequently, the motion compensation prediction unit 64 calculates the motion vector α₀ ·MV_{P} according to the calculation mode 2. Then, the coding amount estimation unit 65 calculates the coding amount of the subtraction image with a predicted image created using the motion vector α₀·MV_{P}. Then, comparison is made between the coding amounts of the two subtraction images thus created. In a case that determination has been made that the coding amount obtained using the motion vector α₀·MV_{P} according to the calculation mode 2 is smaller than that obtained with the calculation mode 1, the motion vector selection unit 67 selects the motion vector according to the calculation mode 2.

On the other hand, in a case that determination has been made that coding amount obtained using the motion vector MV_{B} according to the calculation mode 1 is smaller than that obtained with the calculation mode 2, the motion compensation prediction unit 64 calculates the motion vector α₀·MV_{P}+β₀ according to the calculation mode 3. Then, the coding amount estimation unit 65 calculates the coding amount of the subtraction image in a case of creating a predicted image using the motion vector α₀·MV_{P}+β₀. Then, comparison is made between the coding amount of the subtraction image obtained according to the calculation mode 1 and that according to the calculation mode 3. Then, in a case that determination has been made that the motion vector α₀·MV_{P}+β₀ according to the calculation mode 3 provides a smaller coding amount than that obtained with the calculation mode 1, the motion vector selection unit 67 selects the motion vector according to the calculation mode 3.

Subsequently, the same calculation and comparison are performed for the calculation mode 4 and the calculation mode 5. In a case that the motion vector according to a calculation mode other than the calculation mode 1 has been selected, the aforementioned comparison/computation processing ends.

Such an arrangement enables the motion vector that provides high coding efficiency to be selected while suppressing the computation amount necessary for the coding.

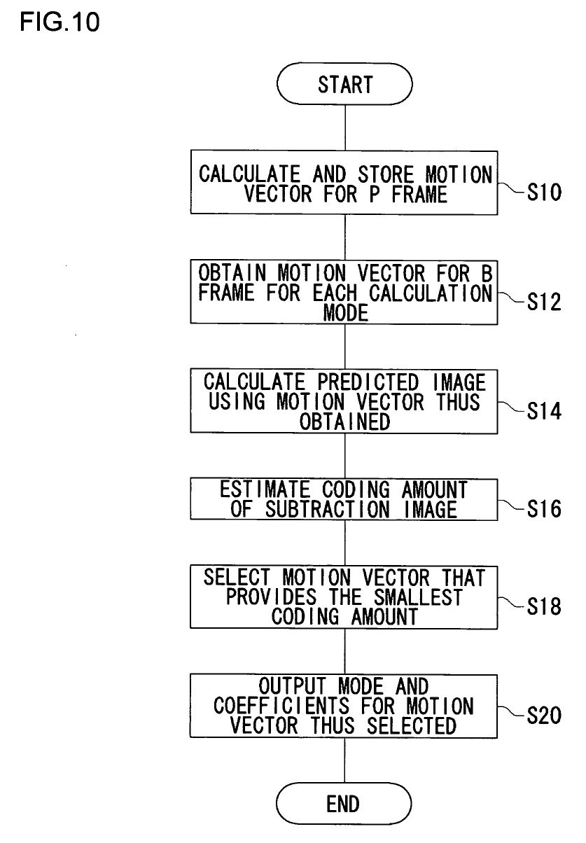

FIG. 10 is a flowchart which shows a selection method for selecting the optimum motion vector. First, the motion compensation unit 60 calculates the motion vector for each macro block defined in the backward reference frame 205 with the forward reference frame 201 as a reference, and stores the motion vectors thus obtained in the motion vector holding unit 61 (S10). The motion vector calculation unit 63 obtains each of the motion vectors according to the calculation modes specified by the calculation mode specifying unit 62 for each macro block defined in the coding target frame 203 using the motion vector obtained for the corresponding macro block defined in the backward reference frame 205 held by the motion vector holding unit 61 (S12). The motion compensation prediction unit 64 calculates a predicted image using the motion vector obtained according to each calculation mode in S12 (S14). The coding amount estimation unit 65 estimates the coding amount of the subtraction image which is the subtraction between the original image and the predicted image calculated by the motion compensation prediction unit 64 (S16). Note that the coding amount may be estimated using an analysis program prepared beforehand. The coding of the subtraction image may be actually performed via the DCT unit 20, the quantization unit 30, and the variable-length coding unit 90, and the coding amount estimation unit 65 may receive the information with respect to the coding amount from the variable-length coding unit 90. The coding amount thus estimated for each calculation mode is stored in the coding amount holding unit 66.

Then, the motion vector selection unit 67 makes a comparison between the coding amounts stored in the coding amount holding unit 66, determines the calculation mode that provides the smallest coding amount, and selects the motion vector calculated according to the calculation mode thus selected (S18). The motion vector selection unit 67 outputs the proportional coefficients α₀ and α₁, and the adjustment vectors β₀ and β₁ to the variable-length coding unit 90 in a case that such components have been generated (S20). The data of the calculation mode, the proportional coefficients, and the adjustment vectors, are included in a coded stream.

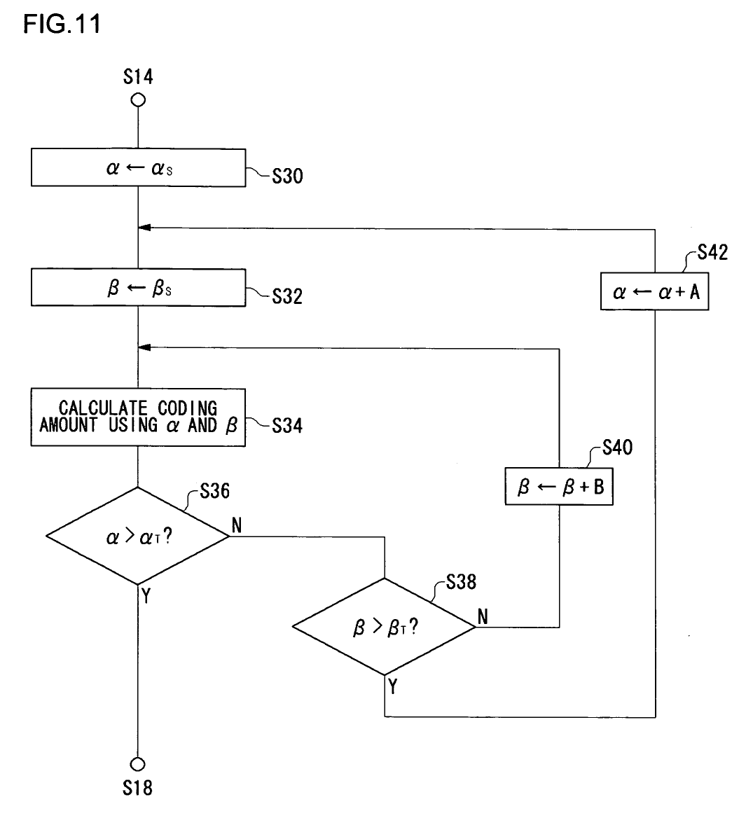

FIG. 11 shows an example of a method for obtaining the optimum combination of the variable proportional coefficient α and the variable adjustment vector β. Let us say that each of the proportional coefficient α and the variable adjustment vector β is determined within a predetermined possible range. Specifically, the proportional coefficient α is determined to be a value in a range between α_{S} and α_{T}. On the other hand, the adjustment vector β is determined to be a value in a range between β_{S} and β_{T}.

First, the motion vector calculation unit 63 substitutes the initial value α_{S} for the proportional coefficient α (S30). Subsequently, the motion vector calculation unit 63 substitutes the initial value β_{S} for the adjustment vector β (S32). The motion vector calculation unit 63 calculates the motion vector αMV_{P}+β, and the coding amount estimation unit 65 estimates the coding amount of the subtraction image in a case of using this motion vector (S34). The motion vector calculation unit 63 determines whether or not the proportional coefficient α exceeds the maximum permissible value α_{T} (S36). In a case that determination has been made that the proportional coefficient α is equal to or smaller than the maximum permissible value, the motion vector calculation unit 63 determines whether or not the adjustment vector β exceeds the maximum permissible value β_{T} (S38). In a case that determination has been made that β does not reach the maximum permissible value β_{T} (in a case of “NO” in S38), the current adjustment vector β is incremented by a predetermined value B, thereby setting a new adjustment vector β (S40). On the other hand, in a case that determination has been made that β has reached the maximum permissible value β_{T} (in a case of “YES” in S38), the current proportional coefficient α is incremented by a predetermined value A, thereby setting a new proportional coefficient α (S42), and the adjustment vector β is reset to the initial value β_{S}. Then, the motion vector calculation is repeatedly performed with the proportional coefficient α and the adjustment vector β thus updated. When the proportional coefficient α reaches the maximum permissible value α_{T} (In a case of “YES” in S36), this routine ends.

With such an arrangement, the optimum motion vector that provides the smallest difference between the predicted image and the reference image can be selected from among the motion vectors obtained for various combinations of the proportional coefficient α and the adjustment vector β. This reduces the coding amount of a moving image, thereby improving the coding efficiency.

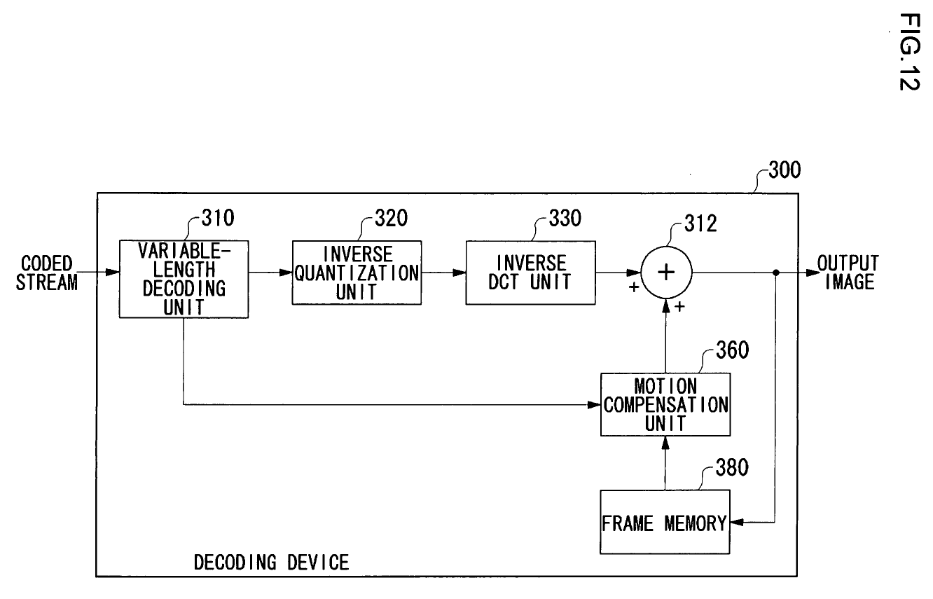

FIG. 12 is a configuration diagram which shows the decoding device 300 according to the embodiment 1. The functional block configuration can also be realized by hardware components alone, software components alone, or combinations thereof.

The decoding device 300 receives a coded stream in the form of input data, and decodes the coded stream, thereby creating an output image.

A variable-length decoding unit 310 performs variable-length decoding of the input coded stream, and transmits the decoded image data to an inverse-quantization unit 320. On the other hand, the variable-length decoding unit 310 transmits the decoded motion vector information to a motion compensation unit 360.

The inverse-quantization unit 320 performs inverse-quantization of the image data decoded by the variable-length decoding unit 310, and transmits the image data thus inverse-quantized to an inverse DCT unit 330. The image data inverse-quantized by the inverse quantized unit 320 is a DCT coefficient set. The inverse DCT unit 330 performs inverse discrete cosine transform (IDCT) for the DCT coefficient set inverse-quantized by the inverse quantization unit 320, thereby reconstructing the original image data. The image data reconstructed by the inverse DCT unit 330 is supplied to an adder 312.

In a case that the image data supplied from the inverse DCT unit 330 is an I frame, the adder 312 outputs the image data which is an I frame without any calculation, and stores the image data in frame memory 380 as a reference image for creating a predicted image of the P frame or B frame.

On the other hand, let us consider a case in which the image supplied from the inverse DCT unit 330 is a P frame. In this case, the image data is a subtraction image, and accordingly, the adder 312 calculates the sum of the subtraction image supplied from the inverse DCT unit 330 and the predicted image supplied from the motion compensation unit 360, thereby outputting the reconstructed original image.

The motion compensation unit 360 creates a predicted image of the P frame or B frame using the motion vector information supplied from the variable-length decoding unit 310, and the reference image stored in the frame memory 380, and supplies the predicted image thus created to the adder 312.

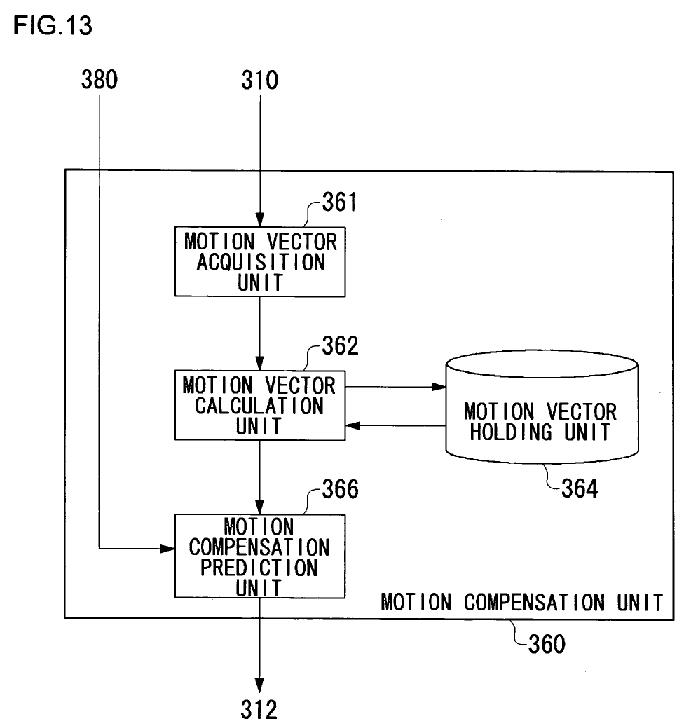

FIG. 13 is a configuration diagram which shows the motion compensation unit 360. Description will be made below regarding the operation of the motion compensation unit 360 for decoding a B frame coded according to the present Embodiment 1. At the time of motion compensation of the backward reference frame, the motion compensation unit 360 detects the motion vector of each macro block defined in the backward reference frame. The motion vector information and the macro block information with respect to the backward reference frame thus detected are held by the motion vector holding unit 364.

The motion vector acquisition unit 361 acquires the motion vector information from the variable-length decoding unit 310. The motion vector information includes the calculation modes, the proportional coefficients α, and the adjustment vectors β described above. The motion vector acquisition unit 361 supplies the motion vector information to a motion vector calculation unit 362. With the present embodiment, the calculation mode is included in the coded stream. Such an arrangement allows the motion compensation unit 360 to reconstruct the original motion vector based upon the proportional coefficients α and the adjustment vectors β even if multiple calculation modes have been used for a single coding target frame.

The motion vector calculation unit 362 acquires the motion vector of each macro block defined in the backward reference P frame from the motion vector holding unit 364, and calculates the motion vector for the coding target frame. The motion vector thus calculated is supplied to the motion compensation prediction unit 366, and is held by the motion vector holding unit 364, which enables the motion vectors to be calculated for other frames.

The motion compensation prediction unit 366 creates a predicted image of the coding target frame using the motion vectors thus received, and outputs the predicted image to the adder 312.

As described above, with the Embodiment 1, multiple motion vectors are prepared in advance of the coding, and the optimum motion vector that provides the smallest difference between the predicted image and the reference image is selected. Such an arrangement reduces the coding amount of a moving image, thereby improving the coding efficiency.

Furthermore, with the present embodiment, each motion vector of the coding target frame is represented using the motion vector of the reference frame where the motion vectors have already been calculated. This reduces the coding amount of the data component for the motion vectors themselves.

In many cases, recent high image quality compression coding requires motion vector search with a ¼ pixel precision. This further increases the coding amount of the motion vector information. With the Embodiment 1, each motion vector of the coding target frame (B frame) is predicted using the corresponding motion vector of the backward reference frame (P frame). Such an arrangement does not require the coding of each B frame motion vector itself. For the B frame, it is sufficient to code only the proportional coefficients α, the adjustment vectors β, and the calculation mode for each motion vector. Furthermore, let us consider a case in which α is specified as the proportional coefficient that represents the movement at a constant speed or the movement at a constant acceleration. In this case, the value of α is calculated based upon the ratio of the frame interval. Accordingly, in this case, there is no need to code the proportional coefficient α. It is sufficient to code only the calculation mode.

Such a method requires an increased calculation processing amount for coding. However, such a method provides highly efficient motion vectors. This reduces the data amount of a coded stream, thereby improving the coding efficiency for a moving image.

Description has been made regarding an arrangement in which B frames are coded in the forward prediction mode. The Embodiment 1 can be applied to an arrangement in which B frames are coded in the backward prediction mode. The Embodiment 1 can be applied to an arrangement in which B frames are coded in the bi-directional prediction mode in which coding is performed for a pair of independent motion vectors representing the motion with respect to the forward reference frame and the motion with respect to the backward reference frame, respectively, as well as in the uni-directional prediction mode. Specifically, multiple motion vectors are prepared for each of the forward prediction mode and the backward prediction mode in the same way as with the present embodiment.

The Embodiment 1 can be applied to the coding of the motion vectors obtained according to the direct mode in which a pair of the forward and backward motion vectors is obtained based upon a single motion vector using the linear prediction method. Specifically, composite vectors are obtained by adding the adjustment vector β to the vectors obtained using a linear prediction method, i.e., according to a linear motion model in the direct mode, thereby preparing multiple motion vectors.

Description has been made regarding the Embodiment 1 with reference to the aforementioned examples. The above-described examples have been described for exemplary purposes only, and is by no means intended to be interpreted restrictively. Rather, it can be readily conceived by those skilled in this art that various modifications may be made by making various combinations of the aforementioned components or the aforementioned processing, which are also encompassed in the technical scope of the Embodiment 1.

Description has been made in the present embodiment regarding an arrangement in which the coding device 100 and the decoding device 300 perform coding and decoding of the moving images in accordance with the MPEG series standards (MPEG-1, MPEG-2, and MPEG-4), the H.26x series standards (H.261, H.262, and H.263), or the H.264/AVC standard. The present embodiment may be applied to an arrangement in which coding and decoding are performed for moving images managed in a hierarchical manner having a temporal scalability. In particular, the present embodiment is effectively applied to an arrangement in which motion vectors are coded with the reduced coding amount using the MCTF technique.

The above-described calculation modes for the motion vectors have been described for exemplary purposes only. The optimum motion vector may be selected from among the motion vectors defined according to other methods. Examples of such calculation methods include: a calculation method in which the motion vector of a different frame is employed without any calculation; a calculation method for obtaining the motion vector by multiplying the motion vector of a different frame by an appropriate coefficient; etc. There is no need to use all the calculation modes prepared beforehand. The calculation mode specifying unit 62 may adjust the calculation amount necessary for motion vector detection by permitting or limiting the use of some of the calculation modes according to the calculation amount, the processor usage status, etc.

Description has been made regarding an arrangement in which the calculation mode which provides the smallest coding amount of the subtraction image is selected from among the multiple motion vector calculation modes in units of macro blocks defined in a coding target frame. The calculation mode which provides the smallest coding amount of the subtraction image may be selected from among the multiple motion vector calculation modes in units of regions other than macro blocks, e.g., for each slice which serves as a coding unit, or for a ROI (Region of Interest) set in a moving image by an ROI setting unit (not shown). With such an arrangement, the same calculation modes as those shown in FIG. 4 may be employed.

Specifically, the motion compensation unit 60 calculates the motion vector in units of slices or ROIs defined in the backward reference frame 205 with the forward reference frame 201 as a reference. Then, the motion vectors thus obtained are stored in the motion vector holding unit 61. The motion vector calculation unit 63 obtains the motion vector for each slice or each ROI defined in the coding target frame 203 using the motion vector of the corresponding slice or the ROI defined in the backward reference frame 205 stored in the motion vector holding unit 61 according to the calculation mode specified by the calculation mode specifying unit 62. The motion compensation prediction unit 64 calculates a predicted image using the motion vectors obtained by the motion vector calculation unit 63 for each calculation mode. The coding amount estimation unit 65 estimates the coding amount of the subtraction image which is the subtraction between the predicted image calculated by the motion compensation prediction unit 64 and the original image. The coding amount thus estimated is stored in the coding amount holding unit 66 in units of calculation modes.

Then, the motion vector selection unit 67 makes a comparison between the coding amounts stored in the coding amount holding unit 66, determines the calculation mode which provides the smallest coding amount, and selects the motion vector calculated according to the calculation mode thus determined. In a case that the proportional coefficients α₀ and α₁ and the adjustment vectors β₀ and β₁ have been generated, the motion vector selection unit 67 outputs such components thus generated to the variable-length coding unit 90, in addition to the calculation mode for calculating the selected motion vector. The data of the calculation mode, the proportional coefficients, and the adjustment vectors, is included in a coded stream in units of slices or ROIs.

The motion vector calculation mode may be determined in units of frames or GOPs, instead of an arrangement in which the motion vector calculation mode is determined in units of macro blocks defined in the coding target frame. With such an arrangement, there are two procedures as follows.

Procedure 1: The motion compensation unit 60 executes coding in units of frames or GOPs for each motion vector calculation mode candidate. That is to say, coding is executed with the motion vectors obtained according to a single particular calculation mode being applied to all the macro blocks or all the regions defined in the frame. In this step, the coded data is not output, and only the coding amount of the coded data is stored in the coding amount holding unit 66. After the coding amount of the coded data is calculated for all the motion vector calculation modes, the motion vector selection unit 67 selects the calculation mode which provides the smallest coding amount. Then, the motion compensation prediction unit 64 executes coding again according to the motion vector calculation mode thus selected. In this step, the coded data is output.

Procedure 2: The motion compensation unit 60 executes coding in units of frames or GOPs for each motion vector calculation mode candidate. That is to say, coding is executed with the motion vectors obtained according to a single particular calculation mode being applied to all the macro blocks or all the regions defined in the frame. In this step, the coded data is not output, and the coding amount holding unit 66 stores the coded data itself and the coding amount thereof. After the coding amount of the coded data is calculated for all the motion vector calculation modes, the motion vector selection unit 67 selects the calculation mode which provides the smallest coding amount. Then, the coding amount holding unit 66 outputs the coded data corresponding to the motion vector calculation mode thus selected.

Making a comparison between the procedure 1 and the procedure 2, the calculation amount necessary for coding with the procedure 1 is greater than that with the procedure 2 by the calculation amount necessary for coding again after the selection of the motion vector calculation mode. However, the procedure 2 requires storage of the coding amount and the coded data itself for each motion vector calculation mode, leading to the need of a larger storage than with the procedure 1. As described above, there is a trade-off relation between the procedure 1 and the procedure 2. Accordingly, the suitable one should be selected according to the situation.

The method according to the present invention may be applied to the motion vectors which represent motion between multiple frames included in each coding hierarchical layer created according to the aforementioned MCTF technique.

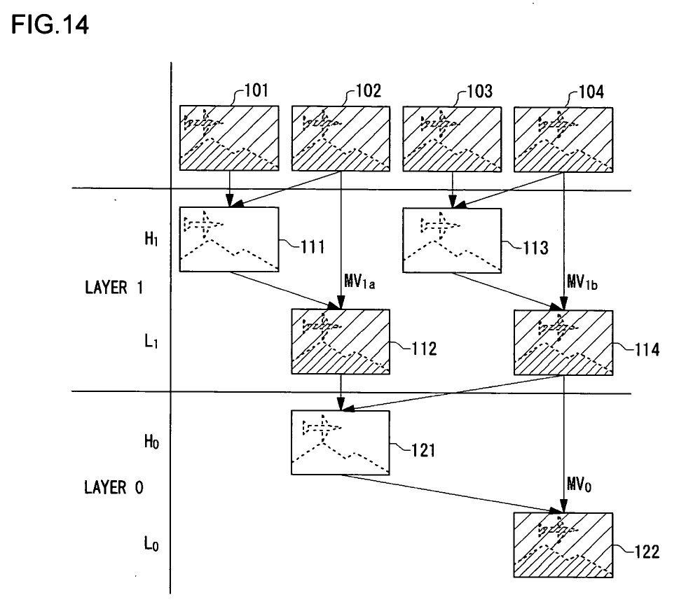

Description will be made regarding such an arrangement with reference to FIG. 14. FIG. 14 shows coding of the four frames 101-104 according to the MCTF technique. Specifically, FIG. 14 shows the images and the motion vectors output for each hierarchical layer.

An MCTF processing unit (not shown) sequentially acquires the two consecutive frames 101 and 102, and creates the high-frequency frame 111 and the low-frequency frame 112. Furthermore, the MCTF processing unit sequentially acquires the two consecutive frames 103 and 104, and creates the high-frequency frame 113 and the low-frequency frame 114. Here, the hierarchical layer including these frames will be referred to as the “hierarchical layer 1”. Furthermore, the MCTF processing unit detects the motion vector MV₁ₐ based upon the two frames 101 and 102, and detects the motion vector MV_{1b} based upon the two frames 103 and 104.

Furthermore, the MCTF processing unit creates the high-frequency frame 121 and the low-frequency frame 122 based upon the low-frequency frames 112 and 114 included in the hierarchical layer 1. The hierarchical layer including these frames thus created will be referred to as the “hierarchical layer 2”. The MCTF processing unit detects the motion vector MV₀ based upon the two low-frequency frames 112 and 114.

For the sake of simplification, FIG. 14 shows an arrangement in which the motion vector is detected in units of frames. The motion vector may be detected in units of macro blocks. The motion vector may be detected for each block (formed of 8×8 pixels or 4×4 pixels).

Let us consider a case in which the above-described method is applied to the coding of the motion vectors MV₁ₐ and MV_{1b} in the hierarchical layer 1 included in a hierarchical structure according to the MCTF technique as shown in FIG. 14. Here, each of the motion vectors MV₁ₐ and MV_{1b} in the hierarchical layer 1 represents the motion for half the period of time for which motion vector MV₀ represents the motion in the hierarchical layer 0. Accordingly, it is predicted that the motion represented by the motion vector in the hierarchical layer 1 is half the motion represented by the motion vector in the hierarchical layer 0. Accordingly, the motion vectors MV₁ₐ and MV_{1b} are calculated by the following Expressions.
MV₁ₐ=(½)·MV₀+βₐ
MV_{1b}=(½)·MV₀+β_{b}
Here, βₐ and β_{b} are adjustment vectors each of which represents the deviation from the predicted value. Accordingly, the motion vector MV₀ in the hierarchical layer 0 and the adjustment vectors βₐ and β_{b} may be coded, instead of the coding of the motion vector MV₁ₐ and MV_{1b} in the hierarchical layer 1.

Note that, as can be understood from the aforementioned Expressions, the motion vectors included in the hierarchical layer 1 cannot be coded before the motion vector MV₀ in the hierarchical layer 0 has been obtained. Accordingly, there is a need to hold the motion vector information and the subtraction information with respect to the hierarchical layer 1 until the motion vector MV₀ in the hierarchical layer 1 is obtained.

The present invention may be applied to the motion vectors in the hierarchical layers other than the hierarchical layer 0 included in a hierarchical structure having three or more hierarchical layers according to the MCTF technique.

### Embodiment 2

### Summary of this Embodiment

It is an object of Embodiment 2 to provide a moving image coding technique which offers high coding efficiency.

An aspect according to the Embodiment 2 is a method for coding pictures of an moving image in which a motion state is estimated for each block over multiple coding target pictures. Furthermore, coded data of a moving image includes the information with respect to the motion mode which represents the motion state thus estimated.

The term “picture” as used herein represents a coding unit. The concept thereof includes the frame, field, and VOP (Video Object Plane). The term “block” defined in a coding target picture represents a pixel set formed of multiple pixels included in a predetermined region such as a macro block or an object, which serves as a target of motion compensation prediction.

With such an aspect, the coded data includes the motion mode which represents the estimated motion state of each block defined in a coded target picture. Such an arrangement provides coding or decoding using such a motion mode.

In a case that reference motion vectors, each of which is a motion vector of a block defined in a second reference picture, have been obtained with a first reference picture as a reference, a coding target motion vector may be obtained for each block defined in each of the coding target pictures with the first reference picture as a reference, a ratio of the vector component of the coding target motion vector to the vector component of the reference motion vector may be obtained for each of the multiple coding target pictures, and the motion state may be estimated for each block with reference to the ratios. With such an arrangement, the motion state of each block defined in a coding target picture is estimated using the corresponding motion vector obtained for the second reference picture, in addition to a function of representing each motion vector defined in the coding target picture using the corresponding motion vector obtained for the second reference picture. Such an arrangement eliminates the need to perform coding of the coding target motion vectors themselves. This reduces the overall coding amount of the motion vector data, thereby improving the coding efficiency for a moving image.

Description will be made below regarding an arrangement in which the forward reference frame is employed as the “first reference picture”, and the backward reference frame is employed as the “second reference picture”. The backward reference frame may be employed as the “first reference picture”, and the forward reference frame may be employed as the “second reference picture”. Description will be made below regarding an arrangement in which the B frame is employed as the “coding target picture”.

A target block, which serves as a target of motion compensation prediction, may be detected for each of the multiple coding target pictures by matching with each block defined in the second reference picture. Furthermore, the coding target vector may be obtained for each block thus detected.

The motion state of each block may be estimated based upon calculation results obtained by calculating the differences between the ratios obtained for the adjacent coding target pictures. Such an arrangement enables the motion state of each block to be estimated in a simple manner.

Coefficients for calculating each of the coding target motion vectors may be obtained based upon the reference motion vector according to the motion mode. Furthermore, coded data of a moving image may include the information with respect to the coefficients thus obtained.

The motion modes may include a constant-speed motion mode in which the corresponding block moves at a constant speed over the coding target pictures. Furthermore, the coefficients may be determined based upon the time interval between the first reference picture and the coding target picture. Such an arrangement eliminates the need to perform coding of the coefficients. This reduces the overall coding amount of the motion vector data, thereby improving the coding efficiency for a moving image.

The motion modes may include a constant-acceleration motion mode in which the corresponding block moves at a constant acceleration over the coding target pictures. Furthermore, the coefficients may be determined based upon the time interval between the first reference picture and the coding target picture. Such an arrangement also eliminates the need to perform coding of the coefficients. This reduces the overall coding amount of the motion vector data, thereby improving the coding efficiency for a moving image.

A constant value closest to each of the coefficients may be selected from multiple constant values to which respective variable-length codes have been assigned beforehand. Furthermore, coded data of a moving image may include the code assigned beforehand to the constant value thus selected. With such an arrangement, there is no need to perform coding of the coefficients themselves. It is sufficient to include only the codes, which have been assigned beforehand to the respective coefficients, in the coded data of a moving image. This suppresses the coding amount of the coded data.

An adjustment vector, which represents the difference between the coding target motion vector and the vector obtained by calculating the product of the reference motion vector and the coefficients, may be obtained. Furthermore, coded data of a moving image may include the information with respect to the adjustment vector. Such arrangement provides the adjustment vector for each macro block, which has a function of compensating for the difference due to the aforementioned constant value being approximated for each coefficient. This prevents a reduction in the precision of the motion compensation prediction. For coding the adjustment vector, a variable-length code may be assigned to each adjustment vector according to the frequency with which the adjustment vector is used.

A single motion mode may be coded for each picture set formed of multiple pictures in the form of information. Furthermore, the coefficient set and the adjustment vector may be coded in the form of information for each of the coding target motion vectors.

Another aspect of the embodiment is a coding method having a function of obtaining a plurality of hierarchical layers having different frame rates by executing motion compensation temporal filtering for pictures of a moving image in a recursive manner, wherein the motion state over a plurality of coding target images included in each layer is estimated. Coded data of a moving image includes the information with respect to the motion mode which indicates the motion state thus estimated.

Note that any combination of the aforementioned components or any manifestation of the Embodiment 2 realized by modification of a method, device, system, computer program, and so forth, is effective as an embodiment of the Embodiment 2.

### DETAILED DESCRIPTION OF THIS EMBODIMENT

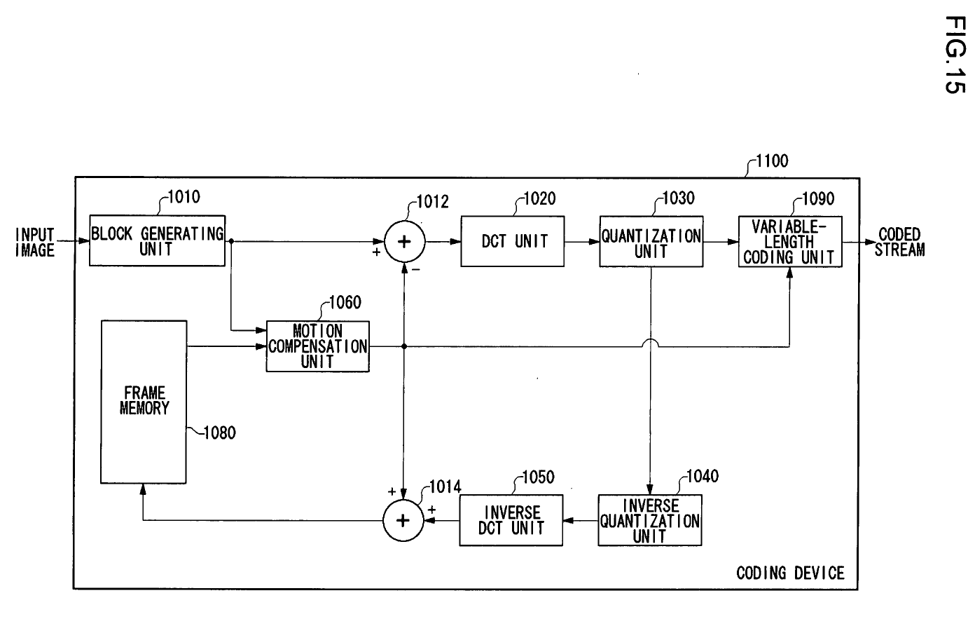

FIG. 15 is a configuration diagram which shows a coding device 1100 according to an embodiment 2. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 1100 according to the present Embodiment 2 performs coding of moving images according to the MPEG (Moving Picture Experts Group) series standards (MPEG-1, MPEG-2, and MPEG-4) standardized by the international standardization organization ISO (International Organization for Standardization)/IEC(International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the aforementioned standardization organizations (these organizations have advised that this H.264/AVC standard should be referred to as “MPEG-4 Part 10: Advanced Video Coding” and “H.264”, respectively).

With the MPEG series standards, in a case of coding an image frame in the intra-frame coding mode, the image frame to be coded is referred to as “I (Intra) frame”. In a case of coding an image frame with a prior frame as a reference image, i.e., in the forward interframe prediction coding mode, the image frame to be coded is referred to as “P (Predictive) frame”. In a case of coding an image frame with a prior frame and an upcoming frame as reference images, i.e., in the bi-directional interframe prediction coding mode, the image frame to be coded is referred to as “B frame”.

On the other hand, with the H.264/AVC standard, image coding is performed using reference images regardless of the time at which the reference images have been acquired. For example, image coding may be made with two prior image frames as reference images. Image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

Note that, in the present specification, the term “frame” has the same meaning as that of the term “picture”. Specifically, the “I frame”, “P frame”, and “B frame” will also be referred to as the “I picture”, “P picture”, and “B picture”, respectively.

Description will be made in the present specification regarding an arrangement in which coding is performed in units of frames. Coding may be made in units of fields. Coding may be made in units of VOPs stipulated in the MPEG-4.

The coding device 1100 receives an input moving image in units of frames, performs coding of the moving image, and outputs a coded stream.

A block generating unit 1010 divides an input image frame into macro blocks. The block generating unit 1010 creates macro blocks in order from the upper-left region to the lower-right region of the frame. The block generating unit 1010 supplies the macro blocks thus generated to a subtractor 1012 and a motion compensation unit 1060.

In a case that the image frame supplied from the block generating unit 1010 is an I frame, the subtractor 1012 outputs the image frame thus received to a DCT unit 1020 without any processing. On the other hand, in a case that the image frame supplied from the block generating unit 1010 is a P frame or B frame, the subtractor 1012 calculates the difference between the frame thus received and a predicted image supplied from the motion compensation unit 1060, and outputs the difference to the DCT unit 1020.

The motion compensation unit 1060 employs a prior frame or an upcoming frame stored in frame memory 1080 as a reference image. Then, the motion compensation unit 1060 searches the reference image for the predicted region which provides the smallest difference for each macro block defined in the P frame or B frame input from the block generating unit 1010, thereby obtaining the motion vector which represents the displacement from the macro block to the predicted region. The motion compensation unit 1060 performs motion compensation for each macro block using the motion vector, thereby creating a predicted image. The motion compensation unit 1060 supplies the motion vector thus created to a variable-length coding unit 1090, and the predicted image thus created to the subtractor 1012 and an adder 1014.

The motion compensation unit 1060 has a function of selecting a prediction mode from among the bi-directional prediction mode and the uni-directional prediction mode. In a case of employing the uni-directional prediction mode, the motion compensation unit 1060 generates a forward motion vector which represents the motion with respect to a forward reference frame. On the other hand, in a case of employing the bi-directional prediction, the motion compensation unit 1060 generates two kinds of motion vectors, i.e., a backward motion vector which represents the motion with respect to a backward reference frame, in addition to the aforementioned forward motion vector.

The subtractor 1012 calculates the difference between the current image (i.e., the coding target image) output from the block generating unit 1010 and the predicted image output from the motion compensation unit 1060, and outputs the difference thus obtained to the DCT unit 1020. The DCT unit 1020 performs discrete cosine transform (DCT) processing for the subtraction image supplied from the subtractor 1012, and supplies the DCT coefficients thus obtained to a quantization unit 1030.

The quantization unit 1030 quantizes the DCT coefficients, and supplies the DCT coefficients thus quantized to the variable-length coding unit 1090. The variable-length coding unit 1090 performs variable-length coding of the quantized DCT coefficients of the subtraction image along with the motion vector supplied from the motion compensation unit 1060, thereby creating a coded stream. Note that the variable-length coding unit 1090 creates the coded stream while sorting the coded frames in time order.

The quantization unit 1030 supplies the quantized DCT coefficients of the image frame to an inverse quantization unit 1040. The inverse quantization unit 1040 performs inverse-quantization of the quantized data thus received, and supplies the data thus subjected to inverse-quantization to an inverse-DCT unit 1050. The inverse-DCT unit 1050 performs inverse discrete cosine transform processing for the inverse-quantized data thus received. As a result, the original image is reconstructed from the coded image frame. The original image thus reconstructed is input to the adder 1014.

In a case that the image frame supplied from the inverse-DCT unit 1050 is an I frame, the adder 1014 stores the image frame thus received in the frame memory without any processing. On the other hand, in a case that the image frame supplied from the inverse-DCT unit 1050 is a P frame or a B frame, i.e., is a subtraction image, the adder 1014 calculates the sum of the subtraction image supplied from the inverse-DCT unit 1050 and the predicted image supplied from the motion compensation unit 1060, thereby reconstructing the original image. Then, the original image thus reconstructed is stored in the frame memory 1080.

Description has been made regarding coding processing for a P frame or B frame, in which the motion compensation unit 1060 operates as described above. On the other hand, in a case of coding processing for an I frame, the I frame subjected to intra-frame prediction is supplied to the DCT unit 1020 without involving the motion compensation unit 1060. Note that this coding processing is not shown in the drawings.

Next, description will be made regarding a conventional calculation method for calculating motion vectors. Then, description will be made regarding a calculation method for calculating motion vectors according to the Embodiment 2.

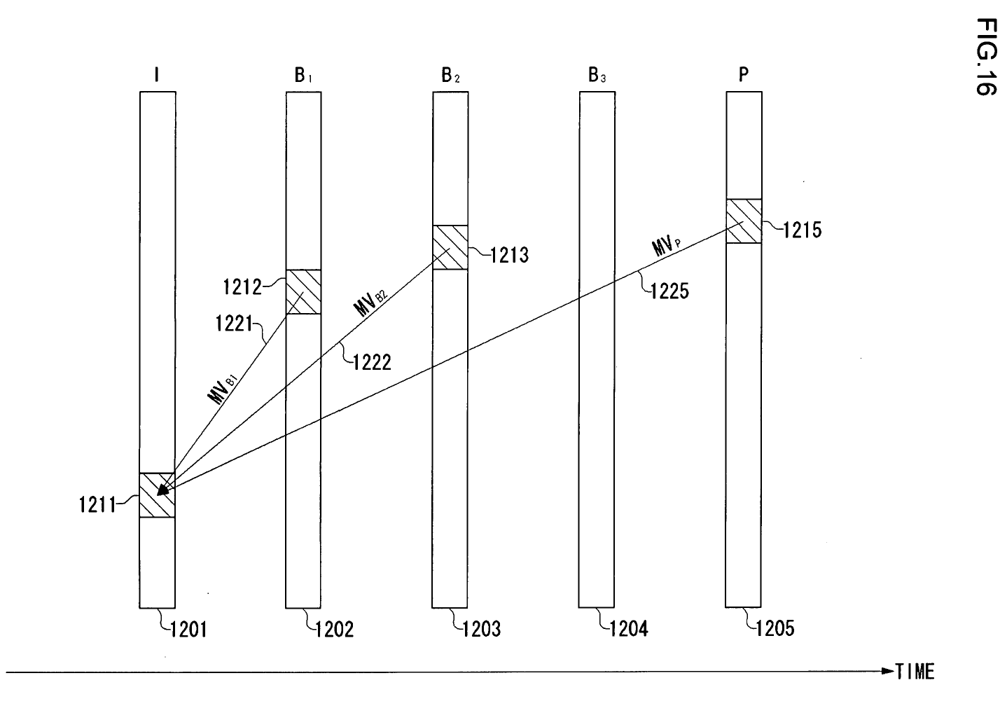

FIG. 16 is a diagram for describing conventional calculation of motion vectors. In FIG. 16, five frames are shown in order of display time, with the movement from left to right representing the passage of time. Specifically, I frame 1201, B₁ frame 1202, B₂ frame 1203, B₃ frame 1204, and P frame 1205 are displayed in that order. Note that the order of coding differs from the order of display. Specifically, first, the I frame 1201 in FIG. 16 is coded. Then, motion compensation is performed for the fifth frame, i.e., the P frame 1205, using the I frame 1201 as a reference image. Subsequently, the B₂ frame 1203 is coded. Then, motion compensation is performed for the B₁ frame 1202 and the B₃ frame 1204 in that order, and coding thereof is performed.

A prior I frame or P frame is employed as a reference frame for coding a target P frame. On the other hand, a prior I frame or a prior or upcoming P frame is employed as a reference frame for coding a target B frame. Here, motion compensation prediction is performed for the P frame using a single motion vector for each 16×16 macro block, for example. On the other hand, motion compensation is performed for the B frame using the one optimum motion compensation mode selected from among three possible options, i.e., the forward prediction mode, the backward prediction mode, and the bi-directional prediction mode. Note that the I frame 1201 may be replaced by a P frame. The P frame 1205 may be replaced by an I frame.

Let us say that the flow enters the stage for coding the B₁ through B₃ frames 202-204 after coding of the I frame 1201 and P frame 1205 has been completed. In this stage, the B₁ through B₃ frames 1202-1204 will be referred to as the “coding target frames”. On the other hand, the I frame 1201, which is displayed prior to the coding target frames will be referred to as the “forward reference frame”. The P frame 1205, which is displayed after the coding target frames, will be referred to as the “backward reference frame”. On the other hand, the motion vector of the P frame 1205 will be represented by “MV_{P}”. The motion vectors of the B₁ through B₃ frames will be represented by “MV_{B1}” through “MV_{B3}”.

Note that, while FIG. 16 shows each two-dimensional frame in a one-dimensional manner, each actual motion vector has two-dimensional components, i.e., horizontal-direction component and the vertical-direction component.

As shown in FIG. 16, the motion vector first obtained is the motion vector MV_{P} 1225 which indicates the displacement of the macro block 1215 defined in the P frame 1205 toward the corresponding macro block 1211 defined in the forward reference frame 1201. The motion vector next obtained is the motion vector MV_{B2} 1222 which indicates the displacement of the macro block 1213 defined in the coding target frame 1203 toward the corresponding macro block defined in either the forward reference frame 1201 or the backward reference frame 1205. FIG. 16 shows an arrangement in which the motion vector indicates the displacement of the macro block 1213 toward the corresponding macro block defined in the forward reference frame 1201. Subsequently, the motion vector next obtained is the motion vector MV_{B1} 1221 which indicates the displacement of the macro block defined in the coding target frame 1202 toward the corresponding macro block defined in either the forward reference frame 1201 or the backward reference frame 1205.

With the Embodiment 2, the coding target motion vector is represented by the product of a coefficient and the motion vector obtained for the backward reference frame or the forward reference frame (which will be referred to as the “reference motion vector” hereafter), and coding is performed for the reference motion vector and the coefficient, instead of the coding of the motion vector itself thus obtained for each macro block defined in the coding target frame (which will be referred to as the “coding target motion vector” hereafter). Such an arrangement enables the coding amount of the motion vector data to be reduced.

Description will be made below regarding an arrangement in which coding is performed using the motion vectors MV_{P} obtained beforehand for the backward reference frame 1205. Coding may be performed using the motion vectors obtained for the forward reference frame 1201 or other motion vectors.

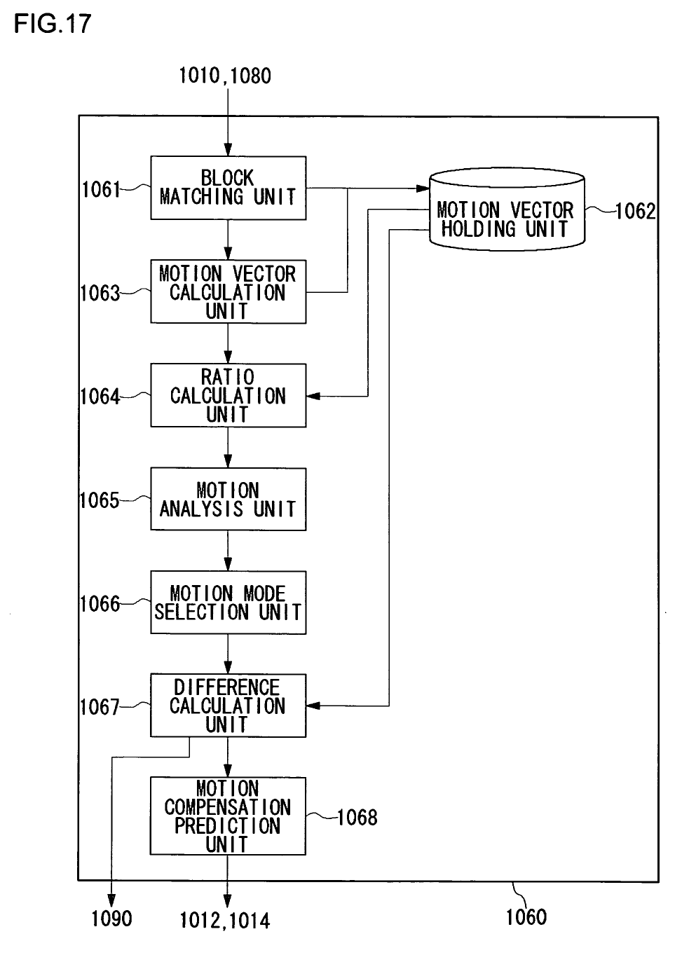

FIG. 17 is a diagram for describing the configuration of the motion compensation unit 1060 according to the Embodiment 2.

At the time of motion compensation of the backward reference frame 1205, the motion compensation unit 1060 detects the motion vector MV_{P} for each macro block defined in the backward reference frame 1205. The motion vector holding unit 1062 holds the motion vector information with respect to the backward reference frame 1205 thus detected beforehand.

A block matching unit 1061 detects the macro block, which serves as a target of motion compensation prediction, for each of the coding target frames 1202-1204, by performing block matching of the macro block defined in the backward reference frame 1205.

The target motion compensation prediction macro block is detected for the coding target frame according to the following procedure. That is to say, first, the motion vector is obtained for each macro block defined in the coding target frame using an ordinary block matching method or the like (which will be referred to as the “ordinary motion vector” in this step). Subsequently, a particular region including the position indicated by the ordinary motion vector is determined in the coding target frame. Then, the motion vector which passes through the region thus determined is extracted from among the motion vectors obtained for the backward reference frame. In a case that multiple motion vectors have been extracted, the motion vector which is closest to the ordinary motion vector obtained beforehand is selected. The motion vector thus extracted or selected serves as the reference motion vector MV_{P} which is to be used as the reference in obtaining the motion vector of the macro block defined in the coding target frame.

A motion vector calculation unit 1063 calculates the motion vectors MV_{B1} through MV_{B3}, each of which indicates the macro block defined in the forward reference frame 1201, for each of the macro blocks defined in the coding target frames 1202-1204.

A ratio calculation unit 1064 calculates the ratio of each of the coding target motion vector MV_{B1} through MV_{B3} obtained for the coding target frames 1202-1204 as to the reference motion vector MV_{P} for each vector component, with reference to the reference motion vector information stored in the motion vector holding unit 1062. The ratios of the coding target motion vectors obtained for the B₁ frame 1202, B₂ frame 1203, and the B₃ frame 1204 to the reference motion vector (which will be represented by “c1”, “c2”, and “c3”, respectively) are represented by the following Expressions.
c₁=[MV_{B1}]/[MV_{P}]
c₂=[MV_{B2}]/[MV_{P}]
c₃=[MV_{B3}]/[MV_{P}]

Here, each of the terms [MV_{B1}] through [MV_{B3}] and the term [MV_{P}] represents the horizontal-direction component or the vertical-direction component of the corresponding motion vector. Here, for the sake of simplification, description is being made regarding an example in which the ratio is calculated for a single direction. In practice, the ratio is calculated for all the vector components.

A motion analysis unit 1065 estimates the state of the motion of the target macro block with reference to the ratios c₁ through c₃ calculated for the respective macro blocks by the ratio calculation unit 1064. Specifically, the motion analysis unit 1065 calculates the difference in the ratio between the macro blocks defined in the adjacent coding target frames. For example, let us consider a case in which there are three coding target frames. In this case, the motion compensation analysis unit 1065 calculates the differences (c₂−c₁) and (c₃−c₂). Then, the motion analysis unit 1065 analyzes the relation between the differences thus calculated.

Let us consider a case in which each of the differences is zero. This means that the motion vector does not change over the coding target frames, and accordingly, it can be assumed that the corresponding macro block remains stationary. On the other hand, let us consider a case in which the differences are not zero, and are approximately the same value. In this case, it can be assumed that the corresponding macro block moves at a constant speed. In a case that the differences increase or decrease in a constant manner, it can be assumed that the corresponding macro block moves at a constant acceleration. In a case that the differences apply to none of the aforementioned cases, it can be assumed that the corresponding macro blocks moves in an irregular manner.

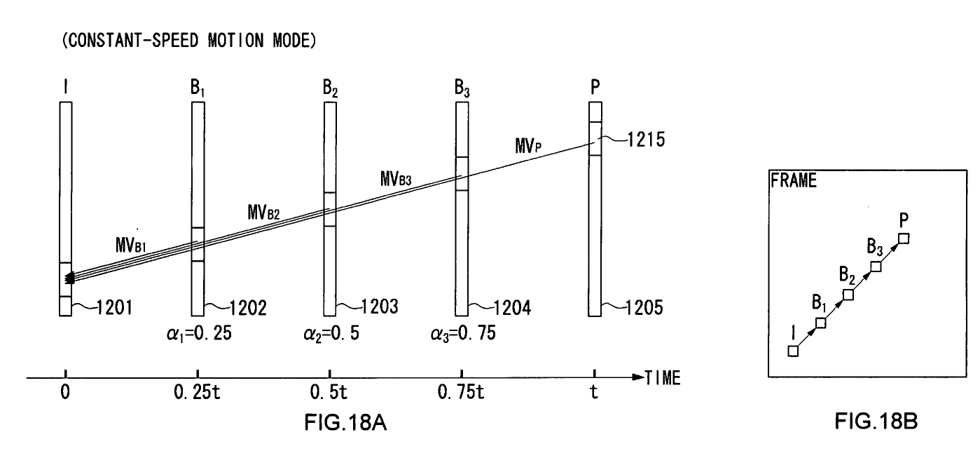

A motion mode selection unit 1066 selects a motion mode based upon the aforementioned estimation results. Examples of the motion modes preferably prepared include: a constant-speed motion mode in which it is assumed that the macro block moves at a constant speed over the coding target frames; and a constant-acceleration motion mode in which it is assumed that the macro block moves at a constant acceleration over the coding target frames. Furthermore, the motion mode selection unit 1066 calculates the coefficients α₁ through α₃ which are to be used for obtaining the coding target motion vector MV_{B1} through MV_{B3} based upon the reference motion vector MV_{P} according to the motion mode thus selected. The coefficients α₁ through α₃ are determined based upon the time interval between the forward reference frame and the corresponding target frame. Description will be made later regarding this calculation with reference to FIGS. 18A through 20A.

A difference calculation unit 1067 calculates each adjustment vector (from β₁ to β₃) which represents the difference between the motion vector (from α₁·MV_{P} to α₃·MV_{P}), which is obtained at the motion mode selection unit 1066 by calculating the product of the reference motion vector MV_{P} and the corresponding coefficient, and the coding target motion vector (from MV_{B1} to MV_{B3}). Description will be made later regarding a calculation method for calculating the adjustment vectors β.

A motion compensation prediction unit 1068 performs motion compensation using the motion vectors (α·MV_{P}+β), each which is represented by the coefficient α and the adjustment vector β for each macro block, thereby creating a predicted image. The predicted image thus created is output to the subtractor 1012 and the adder 1014.

The variable-length coding unit 1090 performs coding of the information which indicates the motion mode selected by the motion mode selection unit 1066, and the coefficients α and the adjustment vector β obtained for each macro block. Thus, the data sets thus coded are included in a coded stream.

Next, description will be made regarding a method for obtaining the coefficients α at the motion mode selection unit 166 with reference to FIGS. 18A through 20A. Note that the same components as those in the conventional method for coding the motion vectors described with reference to FIG. 16 are denoted by the same reference numerals. Description which is the same as that made with reference to FIG. 16 will be omitted.

FIG. 18A shows an example of the relation between the frames in a case that the macro block moves at a constant speed. In a case that the motion mode selection unit 1066 has determined that the macro block moves at a constant speed, the coefficients α₁ through α₃ for the coding target frames 1202-1204 may be obtained such that the motion vector for each frame is obtained in proportion to the time interval between this frame and the forward reference frame. Specifically, the motion vector MV_{P} obtained for the reference macro block 1215 defined in the reference frame 1205 represents the amount and the direction of the motion of the reference macro block 1215 for a period of time t between the backward reference frame 1205 and the forward reference frame 1201. Let us consider a case in which determination has been made that the macro block moves at a constant speed (see FIG. 18B). In this case, it is predicted that the macro block exhibits the motion MV_{P}×(tr/t) for a period of time tr between the coding target frame (1201-1204) and the forward reference frame. Accordingly, in a case that there are three coding target frames as shown in FIG. 18A, the calculation results are the coefficient α₁ of 0.25 for the B₁ frame 1202, the coefficient α₂ of 0.5 for the B₂ frame 1203, and the coefficient α₃ of 0.75 for the B₃ frame 1204.

As described above, in a case of the constant-speed mode, the coefficients α₁ through α₃ can be obtained by calculation. Accordingly, in a case of the constant-speed mode, coding may be performed for the information with respect to the constant-speed motion mode and the reference motion vector MV_{P}, instead of the coding of the motion vectors MV_{B1} through MV_{B3}.

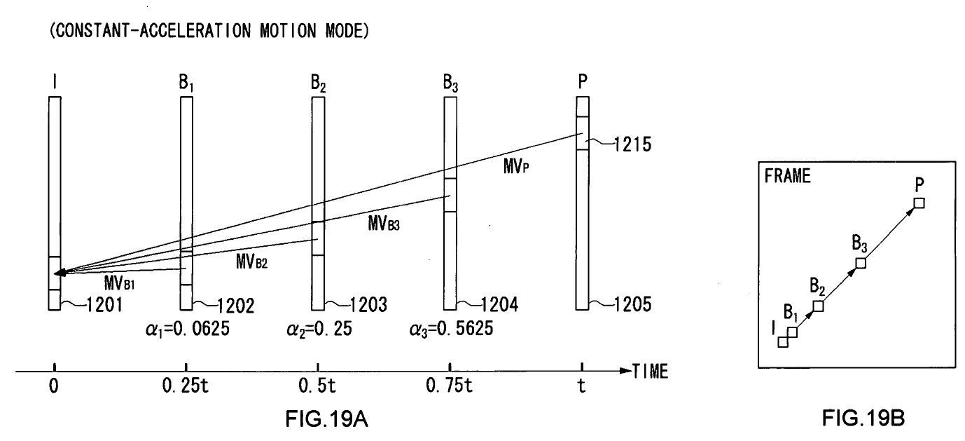

FIG. 19A shows an example of the relation between the frames in a case that the macro block moves at a constant acceleration. In a case that the motion mode selection unit 1066 has determined that the macro block moves at a constant acceleration, the coefficients α₁ through α₃ for the coding target frames 1202-1204 may be obtained such that the motion vector for each frame is obtained based upon the time interval between this frame and the forward reference frame. Let us consider a case in which determination has been made that the macro block moves at a constant acceleration (see FIG. 19B). In this case, it is predicted that the macro block exhibits the motion of MV_{P}×(tr²/t²) for a period of time tr between the coding target frame (1201-1204) and the forward reference frame. In other words, the coefficient α is proportional to the square of the time interval between the coding target frame and the forward reference frame. Accordingly, in a case that there are three coding target frames as shown in FIG. 19A, the calculation results are the coefficient α₁ of 0.0625 for the B₁ frame 1202, the coefficient α₂ of 0.25 for the B₂ frame 1203, and the coefficient α₃ of 0.5625 for the B₃ frame 1204.

As described above, in a case of the constant-acceleration mode, the coefficients α₁ through α₃ can also be obtained by calculation. Accordingly, in a case of the constant-acceleration mode, coding may be performed for the information with respect to the constant-acceleration motion mode and the reference motion vector MV_{P}, instead of the coding of the motion vectors MV_{B1} through MV_{B3}.

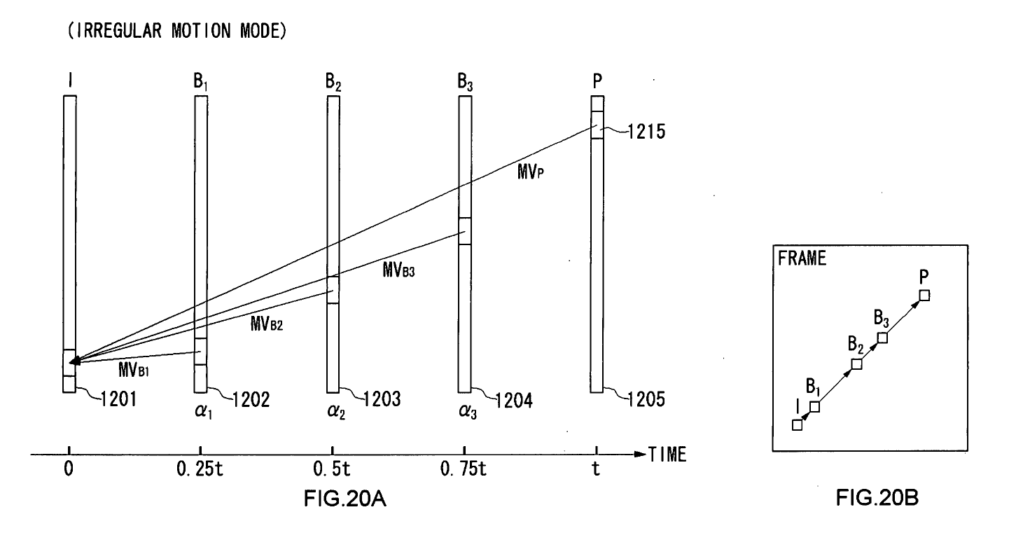

FIG. 20A shows an example of the relation between the frames in a case that the macro block moves in an irregular manner (see FIG. 20B). In this case, the coefficients α₁ through α₃ cannot be obtained by calculation. Accordingly, in this case, the aforementioned ratios c₁ through c₃ are employed as the coefficients of the coding target frames 1202-1204, respectively. That is to say, the calculation results are the coefficient α₁=c₁, the coefficient α₂=c₂, and the coefficient α₃=c₃. With the present embodiment, in a case of the irregular motion mode, coding is performed for the coefficients α₁ through α₃ and the reference motion vector MV_{P}, instead of the coding of the motion vectors MV_{B1} through MV_{B3}.

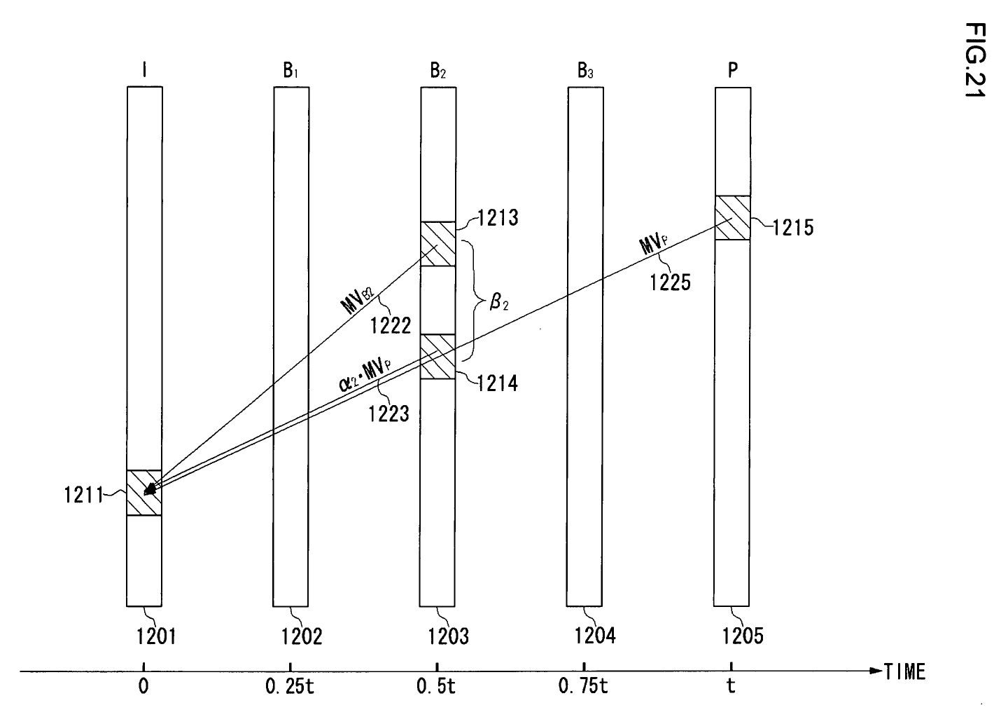

FIG. 21 is a diagram for describing a calculation method for the adjustment vectors β. For example, let us consider a case in which the adjustment vector β₂ is obtained for the B₂ frame 1203. In this case, the adjustment vector β₂ corresponds to the difference between the MV_{B2} 1222 obtained using an ordinary method and α₂·MV_{P} 1223 obtained by calculating the product of the reference motion vector MV_{P} and the coefficient α₂. That is to say, in practice, it is not always the case that the macro block moves at a constant speed over the multiple frames. Accordingly, the adjustment vector β is obtained in order to compensate the difference between the predicted position of the macro block after movement and the actual position of the macro block after movement.

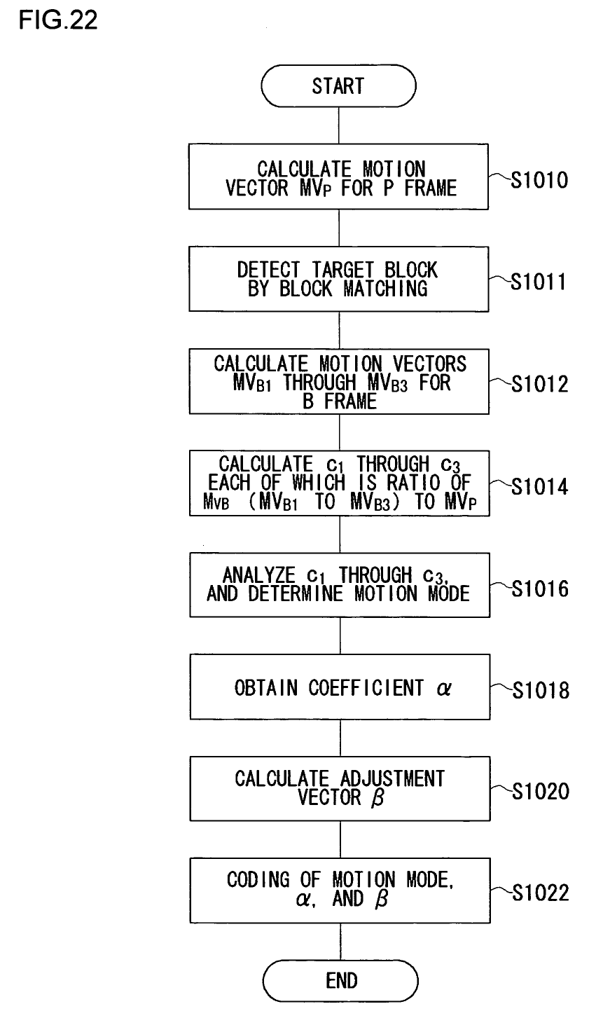

FIG. 22 is a flowchart which shows a coding method for a motion vector according to the Embodiment 2. First, the motion compensation unit 1060 calculates the reference motion vector MV_{P} for each macro block defined in the backward reference frame 1205 with the forward reference frame 1201 as a reference, and the reference motion vectors MV_{P} thus calculated are stored in the motion vector holding unit 1062 (S1010). The block matching unit 1061 identifies the block which serves as a target of motion compensation prediction for each of the coding target frames 1202-1204 using block matching with the macro block defined in the backward reference frame 1205 (S1011). The motion vector calculation unit 1063 obtains the coding target motion vectors MV_{B1} through MV_{B3} for the blocks thus identified with the forward reference frame 1201 as a reference (S1012). The ratio calculation unit 1064 calculates the ratios c₁ through c₃, each of which is the ratio of the coding target motion vector (MV₁ through MV₃), which is obtained for each of the multiple coding target frames, as to the reference motion vector MV_{P} for each vector component (S1014). The motion analysis unit 1065 analyzes the ratios c1 through c3, estimates the motion state of each block over the multiple coding target frames based upon the analysis results thus obtained, and the motion mode selection unit 1066 selects the motion mode which represents the motion state thus estimated (S1016). The motion mode selection unit 1066 obtains the coefficients α₁ through α₃ according to the motion mode thus selected, which allow the coding target motion vectors MV_{B1} through MV_{B3} to be obtained based upon the reference motion vector MV_{P} (S1018). Furthermore, the difference calculation unit 1067 obtains the adjustment vectors β₁ through β₃ each of which represents the difference between the coding target motion vector (from MV_{B1} to MV_{B3}) and the vector obtained by calculating the product of the reference motion vector MV_{P} and the coefficient α (from α₁ to α₃) (S1020). The motion mode, the coefficients α, and the adjustment vectors β, are output to the variable-length coding unit 1090, coding thereof is performed according to the above-described procedure, and the coded information thus created is included in a coded stream.

Note that comparison is made between the component of the coding target motion vector and the component of the reference motion vector for each of both the horizontal direction component and the vertical direction component as described above. In a case of linear motion of the object, the ratio of the coding target motion vector as to the reference motion vector obtained for the horizontal direction component is approximately the same as that obtained for the vertical direction component. Accordingly, in this case, the same information with respect to the motion mode, the coefficients α, and the adjustment vectors β, is employed for the horizontal direction component and the vertical direction component. This further reduces the coding amount. On the other hand, in a case other than the linear motion of the object, coding of the motion mode, the coefficients α, and the adjustment vectors β is performed for each of the horizontal direction component and the vertical direction component.

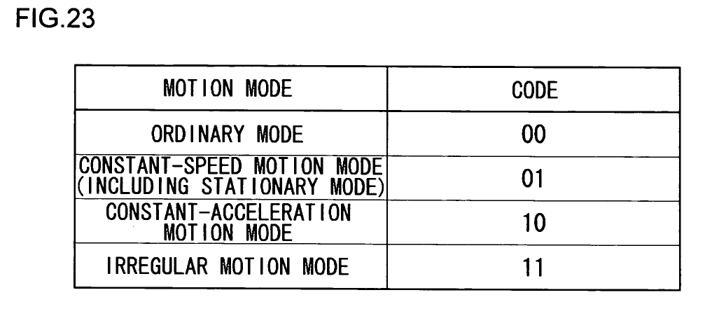

FIG. 23 shows an example of the relation between the motion mode and the code. In this example, the variable-length coding unit 1090 assigns a two-bit code to each motion mode. Here, “ordinary” motion mode shown in FIG. 23 is a motion mode in which the motion vector MV_{B} detected using an ordinary method is employed without any processing.

In a case of the constant-speed motion mode or the constant-acceleration motion mode, the variable-length coding unit 1090 does not need to perform coding of the coefficients α. On the other hand, in a case of the irregular motion mode, there is a need to perform coding of all the coefficients α for each coding target frame.

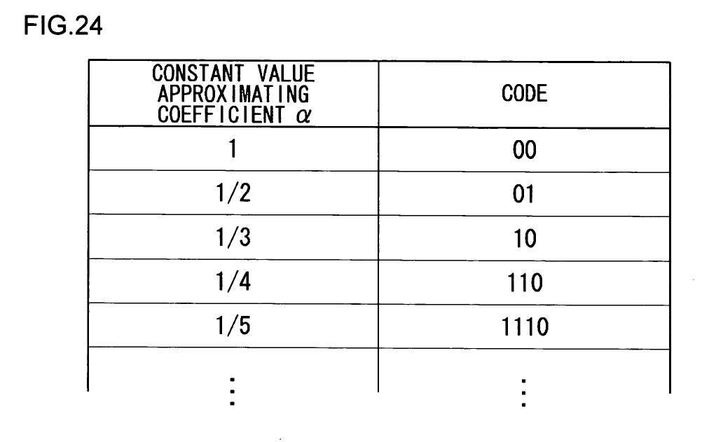

Each coefficient α itself may be coded. However, in general, the coefficients α are decimals. Accordingly, coding of such decimal coefficients often increases the coding amount. In order to solve the aforementioned problem, the variable-length coding unit 1090 may select a constant value closest to the coefficient α from among multiple constant values to which the variable-length codes have been assigned beforehand, and the coded data of a moving image may include the code assigned to the constant value thus selected. FIG. 24 shows an example of the relation between the multiple constant values and the codes assigned to the constant values. As shown in the drawing, the constant values 1, ½, ⅓, ¼, and ⅕ are prepared beforehand, each of which is used to approximate the coefficient α. Furthermore, a variable-length code is assigned to each of these constant values thus prepared. With such an arrangement, the variable-length coding unit 1090 selects the constant value closest to the coefficient α received from the motion compensation unit 1060. Then, the variable-length code assigned beforehand to the constant value thus selected is included in the coded data. This reduces the coding amount of the coefficient α.

Such an arrangement reduces the precision of the motion vector. However, with such an arrangement, the adjustment vectors β are calculated for each macro block. This compensates for the difference due to the reduced precision of the coefficients α, thereby maintaining the precision of the motion compensation prediction at a satisfactory level.

The variable-length coding unit 1090 may assign a variable-length code to each of the adjustment vectors β according to the frequency with which they are used. The variable-length coding unit 1090 may assign a fixed-length code to each of the adjustment vectors β.

For the variable-length coding unit 1090, it is sufficient to perform coding of a single motion mode for each set of multiple frames. Specifically, with the present embodiment, the motion vector is obtained for each of the frames included in each GOP with a given reference frame as a reference. Accordingly, it is sufficient to obtain a single motion mode for each GOP. On the other hand, the coefficients α and the adjustment vectors β need to be coded for each macro block. Note that, in a case that the motion mode of the target macro block is the constant-speed mode or the constant-acceleration mode, there is no need to perform coding of the coefficients α for this target macro block.

The unit for coding using a single motion mode is not restricted to a GOP. For example, in a case that determination has been made that the motion mode of the target macro block is the irregular motion mode, multiple frames may be selected so as to regularize the motion, and a single motion mode may be determined for the multiple frames thus selected.

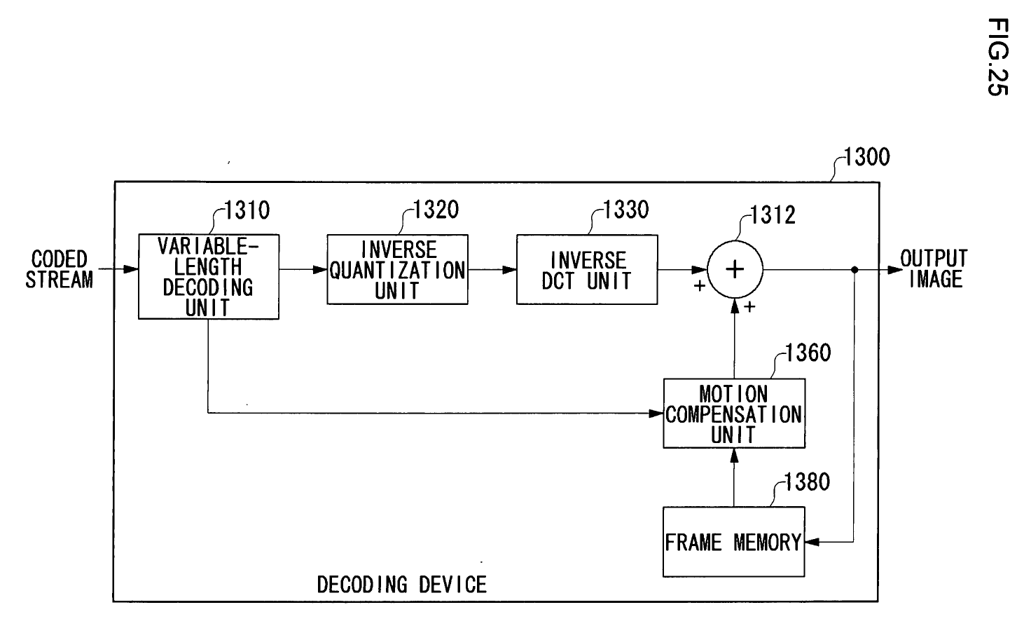

FIG. 25 is a configuration diagram which shows a decoding device 1300 according to the Embodiment 2. Such a functional block configuration can also be realized by hardware components alone, software components alone, or various combinations thereof.

The decoding device 1300 receives the coded stream in the form of input data, and performs decoding of the coded stream, thereby creating an output image.

A variable-length coding unit 1310 performs variable-length decoding of the coded stream thus input. Then, the variable-length coding unit 1310 supplies the image data thus decoded to an inverse quantization unit 1320, and supplies the motion vector information to a motion compensation unit 1360.

The inverse quantization unit 1320 performs inverse quantization of the image data decoded by the variable-length decoding unit 1310, and supplies the image data thus inverse-quantized to an inverse DCT unit 1330. Here, the image data thus inverse-quantized by the inverse quantization unit 1320 is a DCT coefficient set. The inverse DCT unit 1330 performs inverse discrete cosine transform (IDCT) for the DCT coefficient set inverse-quantized by the inverse quantization unit 1320, thereby reconstructing the original data. The image data thus reconstructed by the inverse DCT unit 1330 is supplied to an adder 1312.

In a case that the image data supplied from the inverse DCT unit 1330 is an I frame, the adder 1312 outputs the I frame image data without any processing. Furthermore, frame memory 1380 stores the I frame image data as a reference image used for creating a predicted image for the P frame or B frame.

On the other hand, in a case that the image data supplied from the inverse DCT unit 1330 is a P frame, the image data is a subtraction image. Accordingly, in this case, the adder 1312 calculates the sum of the subtraction image supplied from the inverse DCT unit 1330 and the predicted image supplied from the motion compensation unit 1360, thereby outputting a reconstructed original image.

The motion compensation unit 1360 creates a predicted image for a P frame or a B frame using the motion vector information supplied from the variable-length decoding unit 1310 and the reference image stored in the frame memory 1380. The predicted image thus created is supplied to the adder 1312.

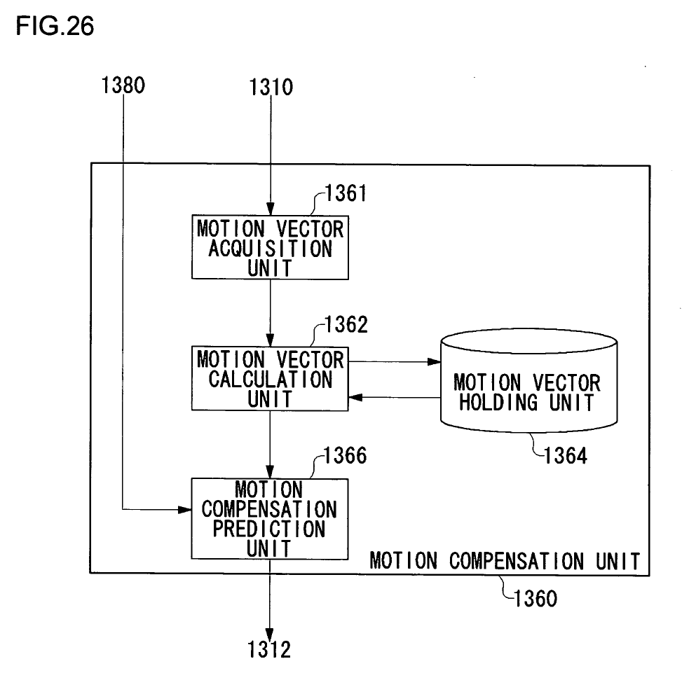

FIG. 26 is a configuration diagram which shows the motion compensation unit 1360. Description will be made below regarding the operation of the motion compensation unit 1360 for decoding the B frame coded according to the present Embodiment 2. At the time of motion compensation of the backward reference frame, the motion compensation unit 1360 detects the motion vector for each macro block defined in the backward reference frame. With such an arrangement, a motion vector holding unit 1364 holds the motion vector information and the macro block information with respect to the backward reference frame thus detected beforehand.

A motion vector acquisition unit 1361 acquires the motion vector information from the variable-length decoding unit 1310. The motion vector information thus acquired includes the aforementioned motion mode, the proportional coefficients α, and the adjustment vectors β. The motion vector acquisition unit 1361 supplies the motion vector information to the vector calculation unit 1362. With the present embodiment, a coded stream includes the motion mode information. This allows the motion compensation unit 1360 to reconstruct the original motion vectors based upon the proportional coefficients α and the adjustment vectors β, even if the macro blocks defined in a coding target frame have been coded according to multiple motion modes.

The motion vector calculation unit 1362 acquires from the motion vector holding unit 1364 the motion vector of each macro block defined in the backward reference P frame. Then, the motion vector calculation unit 1362 calculates the motion vector for the coding target frame based upon the motion vector of the reference P frame thus acquired. The motion vector thus calculated is supplied to the motion compensation prediction unit 1366. The motion vector is held by the motion vector holding unit 1364, which is used for calculation of the motion vectors for other frames.

The motion compensation prediction unit 1366 creates a predicted image for the coding target frame using the motion vector thus received, and outputs the predicted image to the adder 1312.

As described above, with the present Embodiment 2, the motion vectors for each coding target frame (B frame) are represented using the motion vectors obtained for the backward reference frame (P frame). Accordingly, there is no need to perform coding of the motion vectors themselves for each B frame. For such a B frame, it is sufficient to perform coding of the coefficients α, adjustment vectors β, and the motion mode. Furthermore, in a case of the constant-speed mode or the constant-acceleration mode, the coefficients α are obtained based upon the ratio of the coding target frame as to the reference frame. Accordingly, in this case, there is no need to perform coding of the coefficients α. Specifically, in this case, it is sufficient to perform coding of only the adjustment vectors β and the motion mode.

In many cases, recent high image quality compression coding requires detection of motion vectors with ¼ pixel precision. Such an arrangement further increases the coding amount of the motion vector information. While the present Embodiment 2 requires an increased calculation amount for coding, the present Embodiment 2 provides the advantage of a reduced coding amount of the motion vector data. Such an arrangement reduces the data amount of a coded stream, thereby improving the coding efficiency for a moving image.

The conventional direct mode handles only constant-speed motion. On the other hand, the present Embodiment 2 can handle constant-acceleration motion or more complex motion. Thus, the present Embodiment 2 reduces the coding amount of the motion vector data even in such a case.

Description has been made regarding a arrangement in which the present embodiment is applied to the forward prediction for the B frames. The present Embodiment 2 may be applied to the backward prediction in the same way. The present embodiment is not restricted to the uni-directional motion prediction. The present Embodiment 2 may be applied to bi-directional prediction. Specifically, the present Embodiment 2 may be applied to coding of two independent motion vectors which represent the motion with respect to the forward reference frame and the backward reference frame in the bi-directional prediction mode.

Description has been made regarding the present Embodiment 2 with reference to the examples. The above-described examples have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present Embodiment 2.

Description has been made in the present embodiment regarding an arrangement in which the coding device 1100 and the decoding device 1300 perform coding and decoding of the moving images in accordance with the MPEG series standards (MPEG-1, MPEG-2, and MPEG-4), the H.26x series standards (H.261, H.262, and H.263), or the H.264/AVC standard. The present Embodiment 2 may be applied to an arrangement in which coding and decoding are performed for moving images managed in a hierarchical manner having temporal scalability. In particular, the present Embodiment 2 is effectively applied to an arrangement in which motion vectors are coded with a reduced coding amount using the MCTF technique.

Description has been made regarding an arrangement in which the motion mode is estimated based upon the analysis results obtained by analyzing the ratios c. Motion compensation may be performed for each coding target frame using multiple motion vectors according to multiple motion modes so as to create multiple predicted images, and the optimum motion mode is selected from among the multiple motion modes such that the corresponding motion vector provides the smallest coding amount of the subtraction image which is the subtraction between the predicted image and the original image. Description will be made regarding this method.

An coding amount estimation unit (not shown) estimates the coding amount of the coded subtraction image, which is the subtraction between the predicted image and the original image, for each of the constant-speed mode, the constant-acceleration mode, and other motion mode. Each coding amount thus estimated is stored in an coding amount holding unit (not shown) in correlation with the corresponding motion mode.

Then, an motion vector selection unit (not shown) makes a comparison between the coding amounts of the subtraction images held by the coding amount holding unit, and selects the motion mode that provides the smallest coding amount. Such an arrangement reduces the coding amount of the coded data of a moving image, thereby improving the coding efficiency.

Another arrangement may be made in which, only in a case that coding of the subtraction image using the motion vector according to any one of the motion modes provides a smaller coding amount than that using the motion vector MV_{B} obtained according to the ordinary procedure, the motion vector is coded according to this motion mode which provides a smaller coding amount.

Specifically, first, the motion compensation unit 1068 calculates the motion vector MV_{B} according to the ordinary method. Then, an coding amount estimation unit (not shown) calculates the coding amount of the subtraction image with a predicted image created using the motion vector MV_{B}. Subsequently, the motion compensation prediction unit 1068 calculates the motion vector α₀·MV_{P} according to the constant-speed motion mode or the constant-acceleration motion mode. Then, the coding amount estimation unit calculates the coding amount of the subtraction image with a predicted image created using the motion vector α₀·MV_{P}. Then, comparison is made between the coding amounts of the two subtraction images thus created. In a case that determination has been made that the coding amount obtained using the motion vector α₀·MV_{P} according to the constant-speed motion mode or the constant-acceleration motion mode is smaller than that obtained using the ordinary method, the constant-speed motion mode or the constant-acceleration motion mode is selected.

Description has been made regarding an arrangement in which the motion vector is detected in units of macro blocks. The Embodiment 2 may be applied to an arrangement in which the motion vector is detected in units of blocks (8×8 pixel blocks or 4×4 pixel blocks) or in units of objects.

Description has been made regarding an arrangement in which the motion vector for each macro block defined in the coding target frame is represented using the corresponding motion vector obtained for the backward reference frame. The motion vector may be obtained in the same way in units of regions defined in each frame other than macro blocks, e.g., for each slice which serves as a coding unit, or for a ROI (Region of Interest) set in a moving image by an ROI setting unit (not shown).

Specifically, the motion compensation unit 1060 calculates the reference motion vector MV_{P} for each slice or ROI defined in the backward reference frame 1205 with the forward reference frame 1201 as a reference. The reference motion vectors MV_{P} thus calculated are stored in the motion vector holding unit 1062. The block matching unit 1061 detects the corresponding slice or ROI, which serves as a target of motion compensation prediction, defined in each of the coding target frames 1202-1204, by matching with each slice or ROI defined in the backward reference frame 1205. The motion vector calculation unit 1063 obtains the coding target motion vector MV_{B1} through MV_{B3} for each slice or ROI thus detected, with the forward reference frame 1201 as a reference. The ratio calculation unit 1064 obtains the ratio (c₁ through c₃) of the coding target motion vector (MV_{B1} through MV_{B3}) to the reference motion vector MV_{P} for each vector component for each of the multiple coding target frames. The motion analysis unit 1065 analyzes the ratio c₁ through c₃, and estimates the motion state of each slice or ROI over the multiple coding target frames based upon the analysis results. Then, the motion mode selection unit 1066 selects the motion mode which indicates the motion state thus estimated. The motion mode selection unit 1066 obtains the coefficients α₁ through α₃ according to the motion mode thus selected, which allows the coding target motion vectors MV_{B1} through MV_{B3} to be obtained based upon the reference motion vector MV_{P}. Furthermore, the difference calculation unit 1067 obtains the adjustment vectors β₁ through β₃, each of which represents the difference between the coding target motion vector (MV_{B1} through MV_{B3}) and the vector obtained by calculating the product of the reference motion vector MV_{P} and the coefficient (α₁ through α₃). The motion mode, the coefficients α, and the adjustment vectors β are coded according to the above-described procedure. The coded information is included in a coded stream in units of slices or ROIs.

The motion mode may be determined in units of frames or GOPs, instead of an arrangement in which the motion mode is determined in units of macro blocks defined in the coding target frame. With such an arrangement, there are two procedures as follows.

Procedure 1: The motion compensation unit 1060 executes coding in units of frames or GOPs for each motion mode candidate. That is to say, coding is executed with a single particular motion mode being applied to all the macro blocks or all the regions defined in the frame. In this step, the coded data is not output, and only the coding amount of the coded data is stored in a coding amount holding unit (not shown). After the coding amount of the coded data is calculated for all the motion vector calculation modes, the motion vector selection unit 1066 selects the motion mode which provides the smallest coding amount. Then, the motion compensation prediction unit 1068 executes coding again according to the motion vector calculation mode thus selected. In this step, the coded data is output.

Procedure 2: The motion compensation unit 1060 executes coding in units of frames or GOPs for each motion mode candidate. That is to say, coding is executed with a single particular motion mode being applied to all the macro blocks or all the regions defined in the frame. In this step, the coded data is not output, and the coding amount holding unit stores the coded data itself and the coding amount thereof. After the coding amount of the coded data is calculated for all the motion modes, the motion vector selection unit 1066 selects the motion mode which provides the smallest coding amount. Then, the coding amount holding unit outputs the coded data corresponding to the motion mode thus selected.

Making a comparison between the procedure 1 and the procedure 2, the calculation amount necessary for coding with the procedure 1 is greater than that with the procedure 2 by the calculation amount necessary for coding again after the selection of the motion mode. However, the procedure 2 requires storage of the coding amount and the coded data itself for each motion mode, leading to the need of a larger storage region than with the procedure 1. As described above, there is a trade-off relation between the procedure 1 and the procedure 2. Accordingly, the suitable one should be selected according to the situation.

The method according to the present invention may be applied to the motion vectors which represent motion between multiple frames included in each coding hierarchical layer created according to the aforementioned MCTF technique.

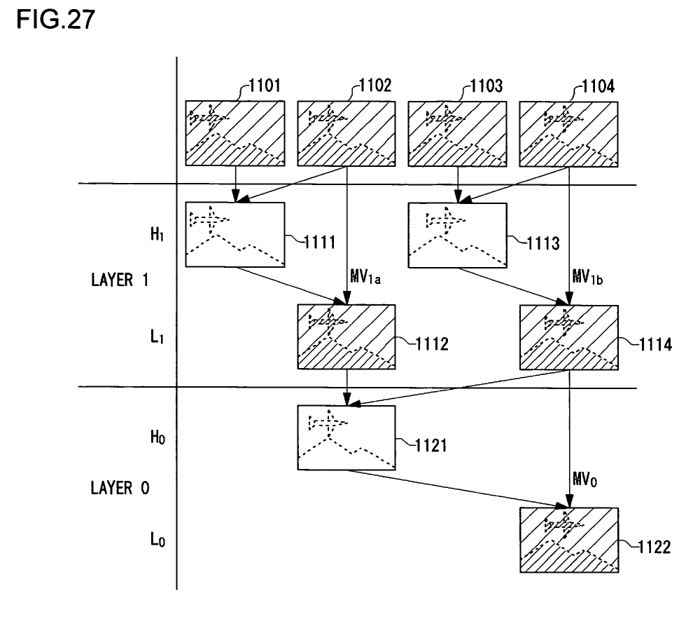

Description will be made regarding such an arrangement with reference to FIG. 27. FIG. 27 shows coding of the four frames 1101-1104 according to the MCTF technique. Specifically, FIG. 27 shows the images and the motion vectors output for each hierarchical layer.

An MCTF processing unit (not shown) sequentially acquires the two consecutive frames 1101 and 1102, and creates the high-frequency frame 1111 and the low-frequency frame 1112. Furthermore, the MCTF processing unit sequentially acquires the two consecutive frames 1103 and 1104, and creates the high-frequency frame 1113 and the low-frequency frame 1114. Here, the hierarchical layer including these frames will be referred to as the “hierarchical layer 1”. Furthermore, the MCTF processing unit detects the motion vector MV₁ₐ based upon the two frames 1101 and 1102, and detects the motion vector MV_{1b} based upon the two frames 1103 and 1104.

Furthermore, the MCTF processing unit creates the high-frequency frame 1121 and the low-frequency frame 1122 based upon the low-frequency frames 1112 and 1114 included in the hierarchical layer 1. The hierarchical layer including these frames thus created will be referred to as the “hierarchical layer 2”. The MCTF processing unit detects the motion vector MV₀ based upon the two low-frequency frames 1112 and 1114.

For the sake of simplification, FIG. 27 shows an arrangement in which the motion vector is detected in units of frames. The motion vector may be detected in units of macro blocks. The motion vector may be detected for each block (formed of 8×8 pixels or 4×4 pixels).

Let us consider a case in which the above-described method is applied to the coding of the motion vectors MV₁ₐ and MV_{1b} in the hierarchical layer 1 included in a hierarchical structure according to the MCTF technique as shown in FIG. 27. Here, each of the motion vectors MV₁ₐ and MV_{1b} in the hierarchical layer 1 represents the motion for half the period of time for which motion vector MV₀ represents the motion in the hierarchical layer 0. Accordingly, it is predicted that the motion represented by the motion vector in the hierarchical layer 1 is half the motion represented by the motion vector in the hierarchical layer 0. Accordingly, the motion vectors MV₁ₐ and MV_{1b} are calculated by the following Expressions.
MV₁ₐ=(½)·MV₀+βₐ
MV_{1b}=(½)·MV₀+β_{b}
Here, βₐ and β_{b} are adjustment vectors each of which represents the deviation from the predicted value. Accordingly, the motion vector MV₀ in the hierarchical layer 0 and the adjustment vectors βₐ and β_{b} may be coded, instead of the coding of the motion vector MV₁ₐ and MV_{1b} in the hierarchical layer 1.

Note that, as can be understood from the aforementioned Expressions, the motion vectors included in the hierarchical layer 1 cannot be coded before the motion vector MV₀ in the hierarchical layer 0 has been obtained. Accordingly, there is a need to hold the motion vector information and the subtraction information with respect to the hierarchical layer 1 until the motion vector MV₀ in the hierarchical layer 1 is obtained.

The present invention may be applied to the motion vectors in the hierarchical layers other than the hierarchical layer 0 included in a hierarchical structure having three or more hierarchical layers according to the MCTF technique.

What is claimed is:

1. A coding method for coding pictures of a moving image, wherein a first motion vector is obtained for each block defined in a coding target picture by a method of matching each block defined in a reference picture and this same block defined in said coding target picture,
and wherein at least one second motion vector is obtained for each block defined in said coding target picture using methods other than said matching method,
and wherein coded data of said moving image includes the information which defines one motion vector selected from among said plurality of motion vectors thus prepared.

2. A coding method according to claim 1, wherein, in a case that there is a second reference picture for which motion vectors have been obtained with a first reference picture as a reference, said second motion vector is obtained for each block defined in said coding target picture using the motion vector of the corresponding block defined in said second reference picture.

3. A coding method according to claim 2, wherein an adjustment vector, which represents the estimated difference between said first motion vector and said second motion vector, is obtained,
and wherein said plurality of motion vectors include a composite vector formed of said adjustment vector and said second motion vector.

4. A coding method according to claim 2, wherein a target block, which serves as a motion compensation prediction target for said coding target picture, is detected based upon each block defined in said second reference picture and the reference motion vector corresponding to said block,
and wherein a second motion vector of said block thus detected is calculated by calculating the product of said reference motion vector and a proportional coefficient obtained based upon the distance in time between said second reference picture and said coding target picture.

5. A coding method according to claim 4, wherein the motion vector selected for said coding target picture is employed as a new reference motion vector,
and wherein said new reference motion vector is used for defining the motion vector for another coding target picture.

6. A coding method according to claim 4, wherein an adjustment vector, which represents the estimated difference between said first motion vector and said second motion vector, is obtained,
and wherein said plurality of motion vectors include a composite vector formed of said adjustment vector and said second motion vector.

7. A coding method according to claim 1, wherein said coded data includes the mode information which indicates which motion vector is selected and used from among said plurality of motion vectors.

8. A coding method for coding pictures of a moving image, wherein a first motion vector calculation mode, which defines first motion vectors obtained by a method of matching a reference picture and a coding target picture, and at least one second motion vector calculation mode, which defines second motion vectors obtained using other methods, are prepared,
and wherein one calculation mode is selected from among said plurality of calculation modes for each picture or for each picture set formed of a plurality of pictures,
and wherein coded data of a moving image includes the information which indicates the calculation mode thus selected.

9. A coding method for coding pictures of a moving image, wherein a motion state is estimated for each block over a plurality of coding target pictures,
and wherein coded data of a moving image includes the information with respect to the motion mode which represents the motion state thus estimated.

10. A coding method according to claim 9, wherein, in a case that reference motion vectors, each of which is a motion vector of a block defined in a second reference picture, have been obtained with a first reference picture as a reference, a coding target motion vector is obtained for each block defined in each of said coding target pictures with said first reference picture as a reference, a ratio of the vector component of said coding target motion vector to the vector component of said reference motion vector is obtained for each of said plurality of coding target pictures, and the motion state is estimated for each block with reference to said ratios.

11. A coding method according to claim 10, wherein a target block, which serves as a target of motion compensation prediction, is detected for each of said plurality of coding target pictures by matching with each block defined in said second reference picture,
and wherein said coding target vector is obtained for each block thus detected.

12. A coding method according to claim 10, wherein the motion state of each block is estimated based upon calculation results obtained by calculating the differences between said ratios obtained for the adjacent coding target pictures.

13. A coding method according to claim 10, wherein coefficients for calculating each of said coding target motion vectors are obtained based upon said reference motion vector according to said motion mode,
and wherein coded data of a moving image includes the information with respect to said coefficients thus obtained.

14. A coding method according to claim 13, wherein said motion modes include a constant-speed motion mode in which the corresponding block moves at a constant speed over said coding target pictures,
and wherein said coefficients are determined based upon the time interval between said first reference picture and said coding target picture.

15. A coding method according to claim 13, wherein said motion modes include a constant-acceleration motion mode in which the corresponding block moves at a constant acceleration over said coding target pictures,
and wherein said coefficients are determined based upon the time interval between said first reference picture and said coding target picture.

16. A coding method according to claim 13, wherein a constant value closest to each of said coefficients is selected from a plurality of constant values to which respective variable-length codes have been assigned beforehand,
and wherein coded data of a moving image includes the code assigned beforehand to the constant value thus selected.

17. A coding method according to claim 13, wherein an adjustment vector, which represents the difference between said coding target motion vector and the vector obtained by calculating the product of said reference motion vector and said coefficients, is obtained,
and wherein coded data of a moving image includes the information with respect to said adjustment vector.

18. A coding method according to claim 9, wherein a single motion mode is coded for each picture set formed of multiple pictures in the form of information,
and wherein said coefficient set and said adjustment vector are coded in the form of information for each of said coding target motion vectors.

19. A coding method for coding pictures of a moving image, wherein the motion state is estimated over a plurality of coding target pictures in units of pictures or picture sets each of which is formed of a plurality of pictures,
and wherein coded data of a moving image includes the information with respect to the motion mode which indicates the motion state thus estimated.
